(19) United States
(12) Patent Application Publication
(10) Pub. No.: US 2024/0251320 A1
(43) Pub. Date: Jul. 25, 2024

(54) APPARATUS AND METHOD FOR PERFORMING LOGGING ACCORDING TO IN-DEVICE COEXISTENCE (IDC) PROBLEM AND RADIO LINK FAILURE (RLF) IN NEXT-GENERATION MOBILE COMMUNICATION SYSTEM

(71) Applicant: Samsung Electronics Co., Ltd., Suwon-si (KR)

(72) Inventor: Sangyeob Jung, Suwon-si (KR)

(21) Appl. No.: 18/412,169

(22) Filed: Jan. 12, 2024

(30) Foreign Application Priority Data
Jan. 12, 2023 (KR) 10-2023-0005015

(51) Int. Cl. H04W 36/30; H04W 36/00

(52) U.S. Cl. CPC H04W 36/305; H04W 36/0069; H04W 36/0079

(57) ABSTRACT

The disclosure relates to a 5G or 6G communication system for supporting a higher data transmission rate. According to an embodiment of the disclosure, a terminal performs a logging procedure in consideration of in-device coexistence (IDC) interference, thereby enabling efficient wireless communication between the terminal and a base station.

### CROSS REFERENCE TO RELATED APPLICATION

The present application claims priority to Korean Patent Application No. 10-2023-0005015, filed on Jan. 12, 2023, the entire contents of which is incorporated by reference herein in its entirety.

### BACKGROUND

### 1. Field

The disclosure relates to actions of a terminal and a base station in a mobile communication system. Specifically, the disclosure relates to an apparatus and method for performing logging according to in-device coexistence (IDC) problem and radio link failure (RLF) in a next-generation mobile communication system.

### 2. Description of the Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Meanwhile, a method to effectively solve in-device coexistence (IDC) interference that may occur due to a plurality of transceivers mounted to access various networks and services is required.

### SUMMARY

An objective of the disclosure is to propose a solution to the problem involving in-device coexistence (IDC) interference that may occur due to a plurality of transceivers mounted on a terminal to access various networks and services.

Accordingly, the embodiments herein provide methods performed by a terminal in a wireless communication system. The method includes in case that a radio link failure (RLF) for a cell is detected, identifying whether a handover from a previous cell to the cell is successfully performed, and identifying whether the handover is associated with a conditional handover (CHO) recovery; and in case that the handover is successfully performed and the handover is not associated with the CHO recovery, storing link failure information to a variable of a RLF report.

Accordingly, the embodiments herein provide methods performed by a terminal in a wireless network. The method includes identifying whether information on a measurement logging is configured: in case that the information on the measurement logging is configured, identifying whether an in-device coexistence (IDC) problem is detected on at least one inter-radio access technology (RAT) frequency during a last logging interval; and in case that the IDC problem is detected on the at least one RAT frequency during the last logging interval, suspending the measurement logging.

Accordingly, the embodiments herein provide a terminal including a transceiver and at least one processor. The at least one processor is configured to in case that a radio link failure (RLF) for a cell is detected, identify whether a handover from a previous cell to the cell is successfully performed, and identify whether the handover is associated with a conditional handover (CHO) recovery, and, in case that the handover is successfully performed and the handover is not associated with the CHO recovery, store link failure information to a variable of a RLF report.

Accordingly, the embodiments herein provide a terminal including a transceiver and at least one processor. The at least one processor is configured to identify whether information on a measurement logging is configured, in case that the information on the measurement logging is configured, identify whether an in-device coexistence (IDC) problem is detected on at least one inter-radio access technology (RAT) frequency during a last logging interval, in case that the IDC problem is detected on the at least one RAT frequency during the last logging interval, suspend the measurement logging.

According to an embodiment of the disclosure, by performing a logging procedure in consideration of in-device coexistence (IDC) interference, it is possible to efficiently perform wireless communication between the terminal and the base station.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a diagram of an architecture of an LTE system according to an embodiment of the disclosure;

FIG. 2 illustrates a diagram of a radio protocol architecture of an LTE system according to an embodiment of the disclosure;

FIG. 3 illustrates a diagram of an architecture of a next-generation mobile communication system according to an embodiment of the disclosure;

FIG. 4 illustrates a diagram of a radio protocol architecture of a next-generation mobile communication system according to an embodiment of the disclosure;

FIG. 5 illustrates a diagram of how a UE experiences an in-device coexistence problem in an NR system according to an embodiment of the disclosure;

FIG. 6 illustrates a diagram of a logging procedure when a UE detects an in-device coexistence problem in an NR system according to an embodiment of the disclosure;

FIG. 7 illustrates a diagram of a logging procedure when a UE detects an in-device coexistence problem in an NR system according to an embodiment of the disclosure;

FIG. 8 illustrates a diagram of a logging procedure when a UE detects an in-device coexistence problem in an NR system according to an embodiment of the disclosure;

FIG. 9 illustrates a diagram of a logging procedure when a UE detects an in-device coexistence problem in an NR system according to an embodiment of the disclosure;

FIG. 10 illustrates a diagram of a logging procedure when a UE detects an in-device coexistence problem in an NR system according to an embodiment of the disclosure;

FIG. 11 illustrates a diagram of a procedure for a UE to successfully perform intra NR handover in an NR system according to an embodiment of the disclosure;

FIG. 12 illustrates a diagram of a procedure in which a UE successfully performs intra NR conditional handover (CHO) in an NR system according to an embodiment of the disclosure;

FIG. 13 illustrates a flowchart of a process in which a UE performs DAPS handover with a base station according to an embodiment of the disclosure;

FIG. 14 illustrates a flowchart of a process in which a UE maintains an RRC connection to a CHO recovery cell through conditional handover (CHO) during an RRC connection re-establishment procedure according to an embodiment of the disclosure;

FIG. 15 illustrates a flowchart in which a UE stores RLF contents and reports the stored RLF contents upon request from a base station when a radio link failure is detected in a cell where the UE has successfully performed a handover (HO), conditional handover (CHO), or dual active protocol stack (DAPS) handover according to embodiments of the disclosure;

FIG. 16 illustrates a block diagram of an internal architecture of a UE according to an embodiment of the disclosure; and

FIG. 17 illustrates a block diagram of an architecture of an NR base station according to an embodiment of the disclosure.

### DETAILED DESCRIPTION

Hereinafter, the operating principle of the disclosure will be described in detail in conjunction with the accompanying drawings. In the following description, a detailed description of known functions or constitutions incorporated herein will be omitted when it may make the subject matter of the disclosure rather unclear. The terms which will be described below are terms defined in consideration of the functions in the disclosure, and may be different according to users, intentions of operators, or customs. Therefore, the definitions of the terms should be made based on the contents throughout the specification.

In the following description of the disclosure, a detailed description of known functions or constitutions incorporated herein will be omitted when it may make the subject matter of the disclosure rather unclear. Hereinafter, embodiments of the disclosure will be described in detail in conjunction with the accompanying drawings.

Terms for identifying access nodes, terms for indicating network entities, terms for indicating messages, terms for indicating interfaces between network entities, and terms for indicating various identification information used in the following explanation are illustrated for convenience of explanation. Therefore, the disclosure is not limited to these terms and other terms having technically equivalent meanings may also be used.

In the following description, a base station is an entity for assigning resources for a terminal and may include at least one of a gNode B, an eNode B, a Node B, a base station (BS), a radio access unit, a base station controller, or a node on a network. A terminal may include a user equipment (UE), a mobile station (MS), a cellular phone, a smart phone, a computer, or a multimedia system capable of performing communication functions. In the disclosure, a downlink (DL) refers to a radio link via which a base station transmits a signal to a terminal, and an uplink (UL) refers to a radio link via which a terminal transmits a signal to a base station. Further, in the following description, LTE or LTE-A systems may be described by way of example, but the embodiments of the disclosure may also be applied to other communication systems having similar technical backgrounds or channel types. For example, 5th generation mobile communication technologies (5G, new radio, and NR) developed beyond LTE-A may be included to the system to which an embodiment of the disclosure is applicable, and in the following description, the 5G may be the concept that covers the exiting LTE, LTE-A, or other similar services. In addition, based on determinations by those skilled in the art, the embodiments of the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

Herein, because these computer program instructions may be loaded into a processor of a general-purpose computer, a special-purpose computer, or other programmable data processing apparatus, the instructions, that are performed by a processor of a computer or other programmable data processing apparatus, create units for performing functions described in the flowchart block(s). The computer program instructions may be stored in a computer-usable or computer-readable memory capable of directing a computer or other programmable data processing apparatus to implement a function in a particular manner, and thus the instructions stored in the computer-usable or computer-readable memory may produce manufacturing items containing instruction units for performing the functions described in the flowchart block(s). The computer program instructions may also be loaded into a computer or other programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

Further, each block of the flowchart illustrations may represent a module, segment, or portion of code, that includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be constructed either to be stored in an addressable storage medium or to execute one or more processors. Therefore, the “unit” includes, for example, elements such as software elements, object-oriented software elements, class elements and task elements, processes, functions, properties, procedures, sub-routines, segments of a program code, drivers, firmware, micro-codes, circuits, data, database, data structures, tables, arrays, and parameters. Functions provided by the elements and “units” may be combined into the smaller number of elements and “units”, or may be divided into additional elements and “units”. Furthermore, the elements and “units” may be embodied to reproduce one or more CPUs in a device or security multimedia card. Also, in an embodiment, the “unit” may include one or more processors.

To facilitate explanation, the disclosure uses terms and names defined in the 3rd Generation Partnership Project (3GPP) long term evolution (LTE) communication standards. However, the disclosure is not limited to these terms and names and may be equally applied to systems conforming to other standards. In the disclosure, the term eNB may be interchangeably used with the term gNB for convenience of explanation. For example, a base station explained as an eNB may also indicate a gNB.

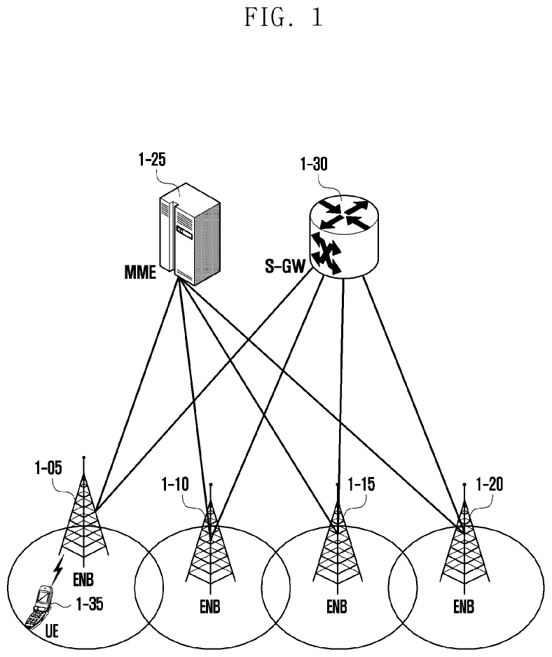

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates a diagram of an architecture of LTE system according to an embodiment of the disclosure.

With reference to FIG. 1, as illustrated, a radio access network of the LTE system includes a next-generation base station (an evolved node B, hereinafter ENB, node B or base station) 1-05, 1-10, 1-15, 1-20, a mobility management entity (MME) 1-25, and a serving-gateway (S-GW) 1-30. A user equipment (hereinafter UE or a terminal) 1-35 may access an external network via the ENB 1-05 to 1-20 and the S-GW 1-30.

In FIG. 1, the ENB 1-05 to 1-20 may correspond to an existing node B of a universal mobile telecommunications system (UMTS) system. The ENB 1-05 is connected to the UE 1-35 through a wireless channel and performs complex functions compared to the existing node B. All user traffics including real-time services such as voice over IP (VOIP) through the Internet protocol are serviced through shared channels in the LTE system. Therefore, an entity for collecting state information, e.g., buffer state information, available transmit power state information, and channel state information, of UEs and performing scheduling may be required and the ENB 1-05 to 1-20 may serve as such an entity. One ENB may generally control a plurality of cells. For example, the LTE system may use a radio access technology such as orthogonal frequency division multiplexing (OFDM) at a bandwidth of 20 MHz to achieve a data rate of 100 Mbps. Further, an adaptive modulation & coding (hereinafter, referred to as AMC) scheme is applied to determine a modulation scheme and a channel coding rate in accordance with the channel status of a terminal. The S-GW 1-30 is an entity for providing data bearers and generates or removes data bearers under the control of the MME 1-25. The MME is an entity for performing a mobility management function and various control functions on the UE and may be connected to the plurality of base stations.

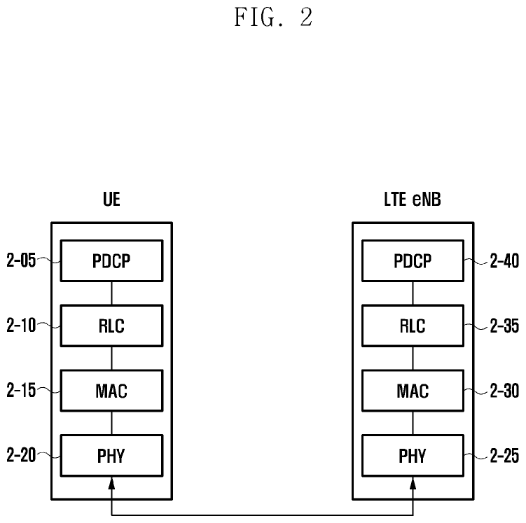

FIG. 2 illustrates a diagram of a radio protocol architecture of an LTE system according to an embodiment of the disclosure.

With reference to FIG. 2, the radio protocol of the LTE system includes packet data convergence protocol (PDCP) 2-05, 2-40, radio link control (RLC) 2-10, 2-35, and media access control (MAC) 2-15, 2-30 respectively for a UE and ENB. The PDCP 2-05, 2-40 may be in charge of IP header compression/decompression, and the like. Main functions of the PDCP are summarized as shown below:
Header compression and decompression function (Header compression and decompression: ROHC only);
User data transfer function (Transfer of user data);
In-sequence delivery function (In-sequence delivery of upper layer PDUs at PDCP re-establishment procedure for RLC AM);
Sequence reordering function (For split bearers in DC (only support for RLC AM): PDCP PDU routing for transmission and PDCP PDU reordering for reception);
Duplication detection function (Duplicate detection of lower layer SDUs at PDCP re-establishment procedure for RLC AM);
Retransmission function (Retransmission of PDCP SDUs at handover and, for split bearers in DC, of PDCP PDUs at PDCP data-recovery procedure, for RLC AM);
Ciphering and deciphering function (Ciphering and deciphering); and
Timer-based SDU discard function (Timer-based SDU discard in uplink).

The radio link control (hereinafter referred to as RLC) 2-10, 2-35 performs an ARQ action and the like by reconstituting PDCP packet data unit (PUD) to appropriate sizes. Main functions of the RLC are summarized as shown below:
Data transfer function (Transfer of upper layer PDUs);
ARQ function (Error Correction through ARQ (only for AM data transfer));
Concatenation, segmentation and reassembly function (Concatenation, segmentation and reassembly of RLC SDUs (only for UM and AM data transfer));
Re-segmentation function (Re-segmentation of RLC data PDUs (only for AM data transfer));
Sequence reordering function (Reordering of RLC data PDUs (only for UM and AM data transfer);
Duplicate detection function (Duplicate detection (only for UM and AM data transfer));
Error detection function (Protocol error detection (only for AM data transfer));
RLC SDU discard function (RLC SDU discard (only for UM and AM data transfer)); and
RLC re-establishment function (RLC re-establishment).

The MAC 2-15, 2-30 is connected to a plurality of RLC layer entities constituted for one UE and perform actions of multiplying RLC PDUs into a MAC PDU and demultiplexing the RLC PDUs from the MAC PDU. Main functions of the MAC are summarized as shown below:
Mapping function (Mapping between logical channels and transport channels);
Multiplexing and demultiplexing function (Multiplexing/demultiplexing of MAC SDUs belonging to one or different logical channels into/from transport blocks (TB) delivered to/from the physical layer on transport channels);
Scheduling information reporting function (Scheduling information reporting);
HARQ function (Error correction through HARQ);
Priority handling function between logical channels (Priority handling between logical channels of one UE);
Priority handling function between UEs (Priority handling between UEs by means of dynamic scheduling);
MBMS service identification function (MBMS service identification);
Transport format selection function (Transport format selection); and
Padding function (Padding).

A physical layer 2-20, 2-25 channel-codes and modulates upper layer data into OFDM symbols and transmits the OFDM symbols through a wireless channel, or demodulates OFDM symbols received through a wireless channel and channel-decodes and delivers the OFDM symbols to an upper layer.

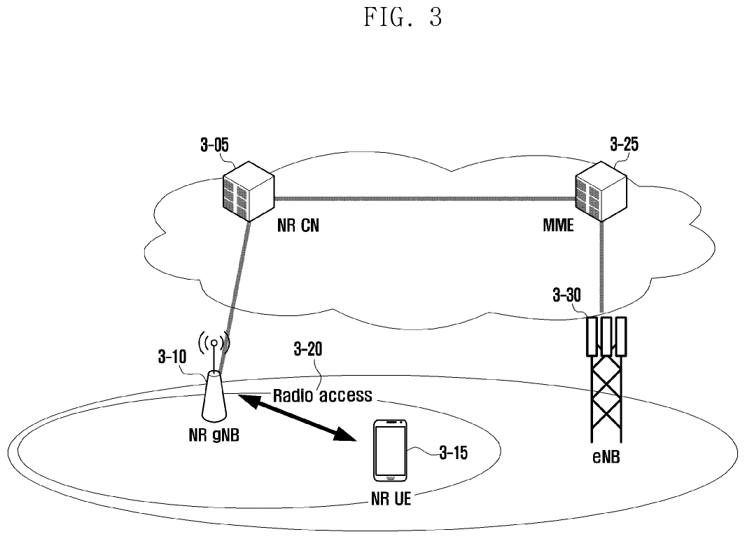

FIG. 3 illustrates a diagram of an architecture of a next-generation mobile communication system according to an embodiment of the disclosure.

With reference to FIG. 3, as illustrated, a radio access network of the next-generation mobile communication system (hereinafter NR or 5G) includes a new radio node B (hereinafter, NR gNB or NR base station) 3-10 and a new radio core network (NR CN) 3-05. A new radio user equipment (NR UE or terminal) 3-15 accesses an external network via the NR gNB 3-10 and NR CN 3-05.

In FIG. 3, the NR gNB 3-10 corresponds to an evolved node B (eNB) of an existing LTE system. The NR gNB 3-10 is connected to the NR UE 3-15 through wireless channels and provides superior services compared to an existing node B. In the next-generation mobile communication system, since all user traffics are served through a shared channel, an entity for collecting status information, such as buffer status, available transmission power status, and channel status of UEs, and performing scheduling is required. The NR gNB 3-10 serves as such an entity. One NR gNB typically controls a plurality of cells. In order to realize super-high data rates compared to the current LTE system, the next-generation mobile communication system may have a bandwidth equal to or greater than the maximum bandwidth of the existing system, may employ, as wireless access technology, orthogonal frequency division multiplexing (hereinafter, referred to as “OFDM”), and may further employ a beamforming technique in addition thereto. In addition, an adaptive modulation & coding (hereinafter, referred to as “AMC”) scheme is applied to determine a modulation scheme and a channel coding rate in accordance with the channel status of a terminal. The NR CN 3-05 performs functions such as mobility support, bearer configuration, and QoS configuration. The NR CN 3-05 is an entity that performs various control functions, as well as a mobility management function for a terminal, and is connected to a plurality of base stations. In addition, the next-generation mobile communication system may interwork with the existing LTE system, and the NR CN 3-05 is connected to an MME 3-25 through a network interface. The MME 3-25 is connected to the eNB 3-30, which is an existing base station.

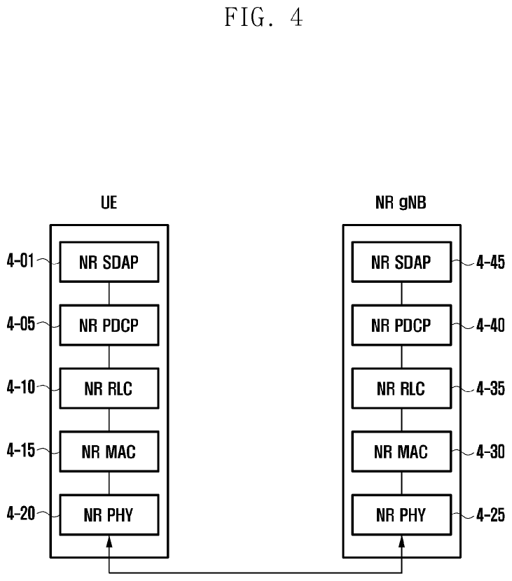

FIG. 4 illustrates a diagram of a radio protocol architecture of a next-generation mobile communication system according to an embodiment of the disclosure.

With reference to FIG. 4, the radio protocol of the next-generation mobile communication system may include a new radio service data adaptation protocol (NR SDAP) 4-01, 4-45, an NR PDCP 4-05, 4-40, an NR RLC 4-10, 4-35, and an NR MAC 4-15, 4-30, respectively for a UE and NR base station.

Main functions of the NR SDAP 4-01, 4-45 may include some of the following functions:
User data transfer function (transfer of user plane data);
Mapping function between a QoS flow and a data bearer for both DL and UL (mapping between a QoS flow and a data radio bearer (DRB) for both DL and UL);
Marking function QoS flow ID in both DL and UL (marking QoS flow ID in both DL and UL packets); and
Mapping function of reflective QoS flow to a data bearer for UL SDAP PDUs (reflective QoS flow to DRB mapping for the UL SDAP PDUs).

With regard to the SDAP layer entity, whether to use a header of the SDAP layer entity or to use functions of the SDAP layer entity may be configured for the UE by using an RRC message per PDCP layer entity, per bearer, or per logical channel. In a case where the SDAP header is configured, the UE may indicate to update or reconfigure UL and DL QoS flow and data bearer mapping information by using a 1-bit NAS reflective QoS indicator and a 1-bit AS reflective QoS indicator of the SDAP header. The SDAP header may include QoS flow ID information indicating QoS. The QoS information may be used as data processing priority information or scheduling information for appropriately supporting a service.

Main functions of the NR PDCP 4-05, 4-40 may include some of the following functions:
Header compression and decompression function (Header compression and decompression: ROHC only);
User data transfer function (Transfer of user data);
In-sequence delivery function (In-sequence delivery of upper layer PDUs);
Out-of-sequence delivery function (Out-of-sequence delivery of upper layer PDUs);
Sequence reordering function (PDCP PDU reordering for reception);
Duplicate detection function (Duplicate detection of lower layer SDUs);
Retransmission function (Retransmission of PDCP SDUs);
Ciphering and deciphering function (Ciphering and deciphering); and
Timer-based SDU discard function (Timer-based SDU discard in uplink).

The above reordering function of the NR PDCP entity, referring to a function of reordering PDCP PDUs received in a lower layer based on a PDCP sequence number (SN), may include a function of transmitting data to an upper layer in the reordered order, or may include a function of directly delivering data without considering the order, or may include a function of reordering the sequence and recording lost PDCP PDUs. Further, the reordering function of the NR PDCP entity may include a function of sending a status report of the lost PDCP PDUs to a transmission side, and may include a function of making a request for retransmission of the lost PDCP PDUs.

Main functions of the NR RLC 4-10, 4-35 may include some of the following functions:
Data transfer function (Transfer of upper layer PDUs);
In-sequence delivery function (In-sequence delivery of upper layer PDUs);
Out-of-sequence delivery function (Out-of-sequence delivery of upper layer PDUs);
ARQ function (Error Correction through ARQ);
Concatenation, segmentation and reassembly function (Concatenation, segmentation and reassembly of RLC SDUs);
Re-segmentation function (Re-segmentation of RLC data PDUs);
Sequence reordering function (Reordering of RLC data PDUs);
Duplicate detection function (Duplicate detection);
Error detection function (Protocol error detection);
RLC SDU dischard function (RLC SDU discard); and
RLC re-establishment function (RLC re-establishment).

The above in-sequence delivery function of the NR RLC entity, referring to a function of delivering RLC SDUs received from a lower layer to an upper layer in sequence, may include a function of, in a case where one original RLC SDU is divided into a plurality of RLC SDUs and received, reassembling and delivering the same. Further, the in-sequence delivery function of the NR RLC entity may include a function of reordering the received RLC PDUs based on an RLC sequence number (SN) or a PDCP sequence number (SN), may include a function of reordering the sequence and recording lost RLC PDUs, may include a function of sending a status report of the lost RLC PDUs to the transmission side, or may include a function of making a request for retransmission of the lost RLC PDUs. Further still, the in-sequence delivery function of the NR RLC entity may include a function of, in a case where there is a lost RLC SDU, delivering only the RLC SDUs prior to the lost RLC SDU to an upper layer in sequence, may include a function of, if a predetermined timer expires even though there is a lost RLC SDU, delivering all RLC SDUs received before the timer starts to an upper layer in sequence, or may include a function of, if a predetermined timer expires even though there is a lost RLC SDU, delivering all RLC SDUs received until the present to an upper layer in sequence. In addition, the RLC PDUs may be processed in the order of reception (in the order of arrival regardless of a serial number or a sequence number thereof), and may be delivered to the PDCP entity in an out-of-sequence delivery manner. In the case of segments, the segments, that are stored in the buffer or will be received later, may be received and reconstituted into one complete RLC PDU, and then processed and delivered to the PDCP entity. The NR RLC layer may not include a concatenation function, which may be performed in the NR MAC layer or may be replaced with a multiplexing function of the NR MAC layer.

The above out-of-sequence delivery function of the NR RLC entity, referring to a function of directly delivering RLC SDUs received from a lower layer to an upper layer regardless of sequence, may include a function of, in a case where one original RLC SDU is divided into a plurality of RLC SDUs and is received, reassembling and delivering the same. Further, the out-of-sequence delivery function of the NR RLC entity may include a function of storing and ordering RLC SNs or PDCP SNs of the received RLC PDUs, thereby recording the lost RLC PDUs.

The NR MAC 4-15, 4-30 is connected to a plurality of NR RLC layer entities constituted for one UE, and main functions of the NR MAC may include some of the following functions:
Mapping function (Mapping between logical channels and transport channels);
Multiplexing and demultiplexing function (Multiplexing/demultiplexing of MAC SDUs);
Scheduling information reporting function (Scheduling information reporting);
HARQ function (Error correction through HARQ);
Priority handling function between logical channels (Priority handling between logical channels of one UE);
Priority handling function between UEs (Priority handling between UEs by means of dynamic scheduling);
MBMS service identification function (MBMS service identification);
Transport format selection function (Transport format selection); and
Padding function (Padding).

The NR PHY layer 4-20, 4-25 may channel-code and modulate upper layer data into OFDM symbols and transmit the OFDM symbols through a wireless channel, or demodulate OFDM symbols received through a wireless channel and channel-decode and deliver the OFDM symbols to an upper layer.

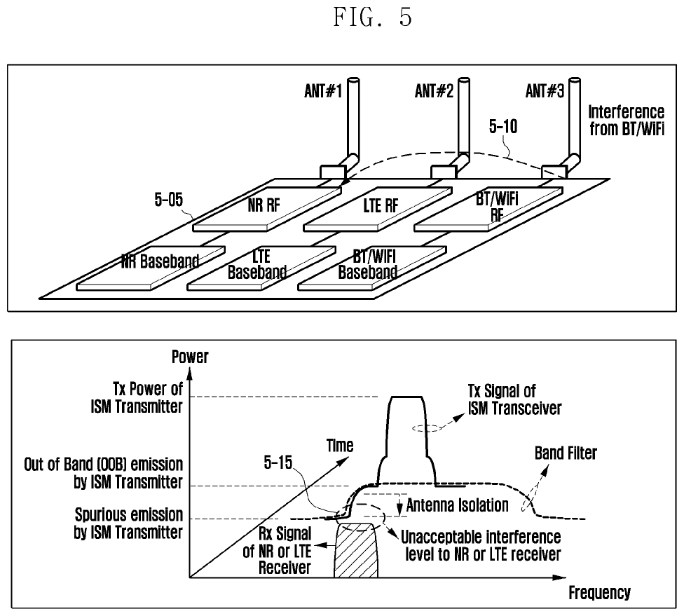

FIG. 5 illustrates a diagram of how a UE experiences an in-device coexistence problem in an NR system according to an embodiment of the disclosure.

With reference to FIG. 5, a UE 5-05 may be equipped with a plurality of radio transcievers to access various networks and services. For example, the UE 5-05 may be equipped with a transceiver such as new radio (NR), long-term evolution (LTE), Bluetooth (BT), and WiFi. Herein, the plurality of transceivers in the UE 5-05 may be mounted in close proximity.

In a case where the plurality of transceivers in the UE 5-05 operate simultaneously at adjacent frequencies or sub-harmonic frequencies, the interference power generated from a specific transmitter may be much greater than the actual received power level of a desired signal of another specific receiver. For example, in a case where a signal is received through an NR receiver in the UE 5-05 and the signal is transmitted using a BT or WiFi transmitter, the transmitted signal from the BT or WiFi transmitter may cause interference to the NR received signal (5-10). Because of this, in a case where the transmitted signal of the BT or WiFi transmitter is larger than the received signal of the NR receiver, in-device coexistence (IDC) interference may occur (5-15). In a particular embodiment to be described later, the occurrence of IDC interference may be referred to as an IDC problem.

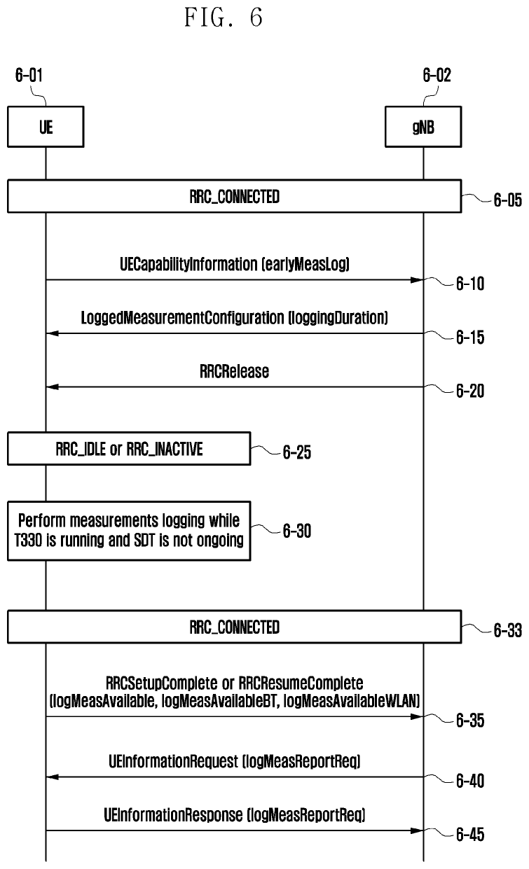

FIG. 6 illustrates a diagram of a logging procedure when a UE detects an in-device coexistence problem in an NR system according to an embodiment of the disclosure.

With reference to FIG. 6, a UE 6-01 may establish an RRC connection with an NR base station 6-02 and be in RRC connected mode (6-05).

In operation 6-10, the UE 6-01 may transmit a UE capability information message (UECapabilityInformation) to the NR base station 6-02. The message may include information on the capability of the UE 6-01 to log and store an early measurement and report the logged measurement result to the base station 6-02 at the request of the base station 6-02 (the storage of Early Measurement Logging in logged measurements and the reporting upon request from the network). In the disclosure, the capability information may be referred to as early MeasLog. For reference, the UE 6-01 in RRC idle mode (RRC_IDLE) or RRC inactive mode (RRC_INACTIVE) may support the capability of suspending (or stopping) logging the measurement results due to IDC interference (logged measurements suspension due to IDC interference), but the capability may not be separately notified to the base station 6-02.

In operation 6-15, the NR base station 6-02 may transmit a logged measurement configuration message (LoggedMeasurementConfiguration) to the UE 6-01 so that the UE 6-01 in RRC idle mode and RRC inactive mode logs the measurement results (perform logging of measurement results while in RRC_IDLE and RRC_INACTIVE). The logged measurement configuration message may include at least one parameter disclosed in Table 1 below.

TABLE 1
LoggedMeasurementConfiguration-r16 ::= SEQUENCE {

| | |
|---|---|
| criticalExtensions | CHOICE { |

loggedMeasurementConfiguration-r16
LoggedMeasurementConfiguration-r16-IEs,

| | |
|---|---|
| criticalExtensionsFuture | SEQUENCE { } |

```
      }
  }
  LoggedMeasurementConfiguration-r16-IEs ::= SEQUENCE {
```

| | |
|---|---|
| traceReference-r16 | TraceReference- |

r16,

| | |
|---|---|
| traceRecordingSessionRef-r16 | OCTET STRING |

(SIZE (2)),

| | |
|---|---|
| tce-Id-r16 | OCTET STRING |

```
(SIZE (1)),
      absoluteTimeInfo-r16
AbsoluteTimeInfo-r16,
      areaConfiguration-r16
```

| AreaConfiguration-r16 | OPTIONAL, --Need R | |
|---|---|---|
| plmn-IdentityList-r16 | | PLMN-IdentityList2- |
| r16 | OPTIONAL, --Need R | |
| bt-NameList-r16 | | SetupRelease |
| {BT-NameList-r16} | OPTIONAL, --Need M | |
| wlan-NameList-r16 | | SetupRelease |
| {WLAN-NameList-r16} | OPTIONAL, --Need M | |
| sensor-NameList-r16 | | SetupRelease |

| | |
|---|---|
| {Sensor-NameList-r16} | OPTIONAL, --Need M |

| | |
|---|---|
| loggingDuration-r16 | LoggingDuration- |

r16,

| | |
|---|---|
| reportType | CHOICE { |

```
        periodical
LoggedPeriodicalReportConfig-r16,
        eventTriggered
LoggedEventTriggerConfig-r16,
        ...
      },
```

| | |
|---|---|
| lateNonCriticalExtension | OCTET STRING |

```
OPTIONAL,
      nonCriticalExtension
LoggedMeasurementConfiguration-v1700-IEs OPTIONAL
  }
  LoggedMeasurementConfiguration-v1700-IEs ::= SEQUENCE {
```

| sigLoggedMeasType-r17 | | ENUMERATED |
|---|---|---|
| {true} | OPTIONAL, -- Need R | |
| earlyMeasIndication-r17 | | ENUMERATED |

| | |
|---|---|
| {true} | OPTIONAL, -- Need R |

areaConfiguration-v1700

| | |
|---|---|
| AreaConfiguration-v1700 | OPTIONAL, --Need R |
| nonCriticalExtension | SEQUENCE { } |

OPTIONAL
}

| | |
|---|---|
| LoggedPeriodicalReportConfig-r16 ::= | SEQUENCE { |

```
      loggingInterval-r16
LoggingInterval-r16,
      ...
    }
```

| | |
|---|---|
| LoggedEventTriggerConfig-r16 ::= | SEQUENCE { |
| eventType-r16 | EventType- |

```
r16,
      loggingInterval-r16
LoggingInterval-r16,
      ...
  }
  EventType-r16 ::= CHOICE {
```

| | |
|---|---|
| outOfCoverage | NULL, |
| eventL1 | SEQUENCE { |
| l1-Threshold | MeasTriggerQuantity, |
| hysteresis | Hysteresis, |
| timeToTrigger | TimeToTrigger |

```
      },
      ...
  }
```

| | |
|---|---|
| AreaConfiguration-r16 ::= | SEQUENCE { |
| areaConfig-r16 | AreaConfig-r16, |
| interFreqTargetList-r16 | SEQUENCE(SIZE (1..maxFreq)) OF |
| InterFreqTargetInfo-r16 | OPTIONAL -- Need R |

}

| | |
|---|---|
| AreaConfiguration-v1700 ::= | SEQUENCE { |
| areaConfig-r17 | AreaConfig- |

r16
OPTIONAL, -- Need R

| | |
|---|---|
| interFreqTargetList-r17 | SEQUENCE(SIZE (1..maxFreq)) OF |
| InterFreqTargetInfo-r16 | OPTIONAL -- Need R |

}

| AreaConfig-r16 ::= | CHOICE { | |
|---|---|---|
| cellGlobalIdList-r16 | | CellGlobalIdList-r16, |
| trackingAreaCodeList-r16 | | TrackingAreaCodeList-r16, |
| trackingAreaIdentityList-r16 | | TrackingAreaIdentityList-r16 |

```
  }
  InterFreqTargetInfo-r16 ::= SEQUENCE {
```

| | |
|---|---|
| dl-CarrierFreq-r16 | ARFCN-ValueNR, |
| cellList-r16 | SEQUENCE (SIZE (1..32)) OF |

| | |
|---|---|
| PhysCellId OPTIONAL | -- Need R |

}

| | |
|---|---|
| CellGlobalIdList-r16 ::= | SEQUENCE (SIZE (1..32)) OF CGI-Info- |

Logging-r16

| | |
|---|---|
| TrackingAreaCodeList-r16 ::= | SEQUENCE (SIZE (1..8)) OF |

TrackingAreaCode
TrackingAreaIdentityList-r16 ::= SEQUENCE (SIZE (1..8)) OF
TrackingAreaIdentity-r16

| | |
|---|---|
| TrackingAreaIdentity-r16 ::= | SEQUENCE { |
| plmn-Identity-r16 | PLMN-Identity, |
| trackingAreaCode-r16 | TrackingAreaCode |

}

Descriptions for various fields set forth in Table 1 are provided in Tables 2 and 3 below.

TABLE 2
LoggedMeasurementConfiguration field descriptions

```
  absoluteTimeInfo
  Indicates the absolute time in the current cell.
  areaConfiguration
  Used to restrict the area in which the UE performs measurement logging to cells
broadcasting either one of the included cell identities or one of the included tracking
area codes/ frequencies.
  earlyMeasIndication
  If included, the field indicates the UE is allowed to log measurements on early
measurement related frequencies in logged measurements.
  eventType
  The value outOfCoverage indicates the UE to perform logging of measurements
when the UE enters any cell selection state, and the value eventL1 indicates the UE to
perform logging of measurements when the triggering condition (similar as event A2
as specified in 5.5.4.3) as configured in the event is met for the camping cell in camped
normally state.
  plmn-IdentityList
  Indicates a set of PLMNs defining when the UE performs measurement logging
as well as the associated status indication and information retrieval i.e. the UE
performs these actions when the RPLMN is part of this set of PLMNs.
  sigLoggedMeasType
  If included, the field indicates a signalling based logged measurements (See TS
37.320 [61]).
  tce-Id
  Parameter Trace Collection Entity Id: See TS 32.422 [52].
  traceRecordingSessionRef
  Parameter Trace Recording Session Reference: See TS 32.422 [52].
  reportType
  Parameter configures the type of MDT configuration, specifically Periodic MDT
configuration or Event Triggerd MDT configuration.
```

TABLE 3
AreaConfiguration field descriptions

```
  InterFreqTargetInfo
  If configured, it indicates the neighbouring frequency and cells for which UE is
requested to perform measurement logging. It can include sync raster or non-sync
raster frequencies.
```

Upon receiving the logged measurement configuration message, the UE 6-01 may perform the procedure disclosed in Table 4 below.

TABLE 4

| | |
|---|---|
| 1> | discard the logged measurement configuration as well as |

the logged measurement information as specified in 5.5a.2;

| | |
|---|---|
| 1> | store the received loggingDuration, reportType and |

areaConfiguration, if included, in VarLogMeasConfig;

| | |
|---|---|
| 1> | if the LoggedMeasurementConfiguration message includes |

plmn-IdentityList:

| | |
|---|---|
| 2> | set plmn-IdentityList in VarLogMeasReport to include the |

RPLMN as well as the PLMNs included in plmn-IdentityList;

| | |
|---|---|
| 1> | else: |
| 2> | set plmn-IdentityList in VarLogMeasReport to include the |

RPLMN;

| | |
|---|---|
| 1> | store the received absoluteTimeInfo, traceReference, |

traceRecordingSessionRef, and tce-Id in VarLogMeasReport;

| | |
|---|---|
| 1> | store the received bt-NameList, if included, in |

VarLogMeasConfig;

| | |
|---|---|
| 1> | store the received wlan-NameList, if included, in |

VarLogMeasConfig;

| | |
|---|---|
| 1> | store the received sensor-NameList, if included, in |

VarLogMeasConfig;

| | |
|---|---|
| 1> | start timer T330 with the timer value set to the |

loggingDuration;

| | |
|---|---|
| 1> | store the received sigLoggedMeasType, if included, in |

VarLogMeasReport;

| | |
|---|---|
| 1> | store the received earlyMeasIndication, if included, in |

VarLogMeasConfig;

In operation 6-20, the NR base station 6-02 may transmit an RRC connection release message (RRCRelease) to the UE 6-01 to release the RRC connection with the UE 6-01. The RRC connection release message may include suspension configuration information (suspendConfig).

In operation 6-25, the UE 6-01 may apply the received RRC connection release message and transition to the RRC idle mode or RRC inactive mode. For example, the UE 6-01 may transition to the RRC inactive mode in a case where the RRC connection release message includes suspension configuration information. In a case where the RRC connection release message does not include suspension configuration information, the UE 6-01 may transition to the RRC idle mode.

In operation 6-30, the UE 6-01 may perform measurement logging in a case where a T330 timer is running and small data transmission (SDT) is not in progress. For reference, the UE 6-01 runs the T330 timer in operation 6-15, and the T330 timer value may be set to loggingDuration included in the logged measurement configuration message received in operation 6-15. Specifically, the UE 6-01 may perform measurement logging through the procedures disclosed in Table 5 below.

```
TABLE 5
      1>  if measurement logging is suspended:
      2>  if during the last logging interval the IDC problems
detected by the UE is resolved, resume measurement logging;
      1>  if not suspended, perform the logging in accordance with
the following:
        2>  if the reportType is set to periodical in the
  VarLogMeasConfig:
          3> if the UE is in any cell selection state (as specified in TS
    38.304 [20]):
            4>  perform the logging at regular time intervals, as
      defined by the loggingInterval in the VarLogMeasConfig;
          3> if the UE is in camped normally state on an NR cell and if
    the RPLMN is included in plmn-IdentityList stored in
    VarLogMeasReport:
            4>  if areaConfiguration is not included in
      VarLogMeasConfig; or
            4>  if the serving cell is part of the area indicated by
      areaConfig in areaConfiguration in VarLogMeasConfig:
              5>  perform the logging at regular time intervals, as
        defined by the loggingInterval in the VarLogMeasConfig;
        2>  else if the reportType is set to eventTriggered, and
  eventType is set to outOfCoverage:
          3> perform the logging at regular time intervals as defined by
    the loggingInterval in VarLogMeasConfig only when the UE is in any
    cell selection state;
          3> upon transition from any cell selection state to camped
    normally state in NR:
            4>  if the RPLMN is included in plmn-IdentityList
      stored in VarLogMeasReport; and
            4>  if areaConfiguration is not included in
      VarLogMeasConfig or if the current camping cell is part of the area
      indicated by areaConfig of areaConfiguration in
      VarLogMeasConfig:
              5>  perform the logging;
        2>  else if the reportType is set to eventTriggered and
  eventType is set to eventL1:
          3> if the UE is in camped normally state on an NR cell and if
    the RPLMN is included in plmn-IdentityList stored in
    VarLogMeasReport:
            4>  if areaConfiguration is not included in
      VarLogMeasConfig; or
            4>  if the serving cell is part of the area indicated by
      areaConfig in areaConfiguration in VarLogMeasConfig;
              5>  perform the logging at regular time intervals as
        defined by the loggingInterval in VarLogMeasConfig only when
        the conditions indicated by the eventL1 are met;
        2>  when performing the logging:
          3> if InterFreqTargetInfo is configured and if the UE detected
    IDC problems on at least one of the frequencies included in
    InterFreqTargetInfo during the last logging interval, or
          3> if InterFreqTargetInfo is not configured and if the UE
    detected IDC problems during the last logging interval:
            4> if measResultServingCell in the VarLogMeasReport
      is not empty:
              5> include inDeviceCoexDetected;
              5> suspend measurement logging from the next
        logging interval;
            4> else:
              5> suspend measurement logging;
          3> set the relativeTimeStamp to indicate the elapsed time
    since the moment at which the logged measurement configuration
    was received;
          3> if location information became available during the last
    logging interval, set the content of the locationInfo as in 5.3.3.7:
          3> if the UE is in any cell selection state (as specified in TS
    38.304 [20]):
            4> set anyCellSelectionDetected to indicate the
      detection of no suitable or no acceptable cell found;
            4> if the reportType is set to eventTriggered in the
      VarLogMeasConfig; and
            4> if the RPLMN at the time of entering the any cell
      selection state is included in plmn-IdentityList stored in
      VarLogMeasReport; and
            4> if areaConfiguration is not included in
      VarLogMeasConfig or if the last suitable cell that the UE was
      camping on is part of the area indicated by areaConfig of
      areaConfiguration in VarLogMeasConfig:
              5> set the servCellIdentity to indicate global cell
        identity of the last suitable cell that the UE was camping on;
              5> set the measResultServingCell to include the
        quantities of the last suitable cell the UE was camping on;
            4> else if the reportType is set to periodical in the
      VarLogMeasConfig:
              5> set the servCellIdentity to indicate global cell
        identity of the last logged cell that the UE was camping on;
              5> set the measResultServingCell to include the
        quantities of the last logged cell the UE was camping on;
          3> else:
            4> set the servCellIdentity to indicate global cell
      identity of the cell the UE is camping on;
            4> set the measResultServingCell to include the
      quantities of the cell the UE is camping on;
          3> if available, set the measResultNeighCells, in order of
    decreasing ranking-criterion as used for cell re-selection, to include
    measurements of neighbouring cell that became available during the
    last logging interval and according to the following:
            4> include measurement results for at most 6
      neighbouring cells on the NR serving frequency and for at most 3
      cells per NR neighbouring frequency and for the NR neighbouring
      frequencies in accordance with the following:
              5> if interFreqTargetInfo is included in
        VarLogMeasConfig:
                6> if earlyMeasIndication is included in
          VarLogMeasConfig;
                  7> include measurement results for NR
            neighbouring frequencies that are included in both
            interFreqTargetInfo and either in measIdleCarrierListNR
            (within the VarMeasIdleConfig) or SIB4;
                6> else:
                  7> include measurement results for NR
            neighbouring frequencies that are included in both
            interFreqTargetInfo and SIB4;
              5> else:
                6> if earlyMeasIndication is included in
          VarLogMeasConfig;
                  7> include measurement results for NR
            neighbouring frequencies that are included in either
            measIdleCarrierListNR (within the VarMeasIdleConfig)
            or SIB4;
                6> else:
                  7> include measurement results for NR
            neighbouring frequencies that are included in SIB4;
            4> include measurement results for at most 3
      neighbours per inter-RAT frequency in accordance with the
      following:
              5> if earlyMeasIndication is included in
        VarLogMeasConfig:
                6> include measurement results for inter-RAT
          neighbouring frequencies that are included in either
          measIdleCarrierListEUTRA (within the VarMeasIdleConfig)
          or SIB5;
              5> else:
                6> include measurement results for inter-RAT
          frequencies that are included in SIB5;
            4> for each neighbour cell included, include the
      optional fields that are available;
          NOTE 1: The UE includes the latest results of the available
    measurements as used for cell reselection evaluation in RRC_IDLE or
    RRC_INACTIVE, which are performed in accordance with the
    performance requirements as specified in TS 38.133 [14].
          NOTE 2: For logging the measurements on frequencies
    (indicated in measIdleCarrierListNR/measIdleCarrierListEUTRA) in
    the logged measurement, the qualityThreshold in measIdleConfig
    should not be applied, and how the UE logs the measurements on
    the frequenciesis left to the UE implementation.
        2>  when the memory reserved for the logged measurement
  information becomes full, stop timer T330 and perform the same actions
  as performed upon expiry of T330, as specified in 5.5a.1.4.
```

The UE 6-01, according to an embodiment of the disclosure, may be characterized in performing the following procedure if InterFreqTargetInfo (or interFreqTargetList) is configured, and only in a case where the IDC problems are detected on at least one frequency included in interFreqTargetInfo (or interFreqTargetList) during the last logging interval (if the UE detected IDC problems on at least one of the frequencies included in InterFreqTargerInfo or interFreqTargetList during the last logging interval):
In a case where the measurement result of a serving cell in the VarLogMeasReport is not empty (if measResultServingCell in the VarLogMeasReport is not empty), the UE may include inDeviceCoexDetected and suspend measurement logging from the next logging interval (include inDeviceCoexDetected and suspend measurement logging from the next logging interval).
Otherwise (for example, in a case where the measurement result of the serving cell in VarLogMeasReport is empty), the UE may suspend measurement logging (suspend measurement logging).

For example, the UE 6-01, according to an embodiment of the disclosure, may be characterized as not suspending measurement logging in a case where the IDC problem is detected at the LTE frequency in a case where InterFreqTargetInfo (or interFreqTargetList) is configured. However, since the UE 6-01 may also log the measurement results for LTE frequency regardless of whether InterFreqTargetInfo (or interFreqTargetList) is configured (see NOTE 1 in Table 5 above), the UE 6-01 may also report polluted or contaminated logging measurement results to the UE 6-02 later.

The UE 6-01 in RRC idle mode or RRC inactive mode transitions to the RRC connected mode through an RRC connection establishment procedure or RRC connection resume procedure (6-33), and may transmit an RRC connection establishment complete message (RRCSetupComplete) or RRC connection resumption complete message (RRCResumeComplete) to the NR base station 6-02 (6-35). For reference, the UE 6-01 may perform the RRC connection establishment procedure in a case where the UE is in RRC idle mode, and perform the RRC connection resumption procedure in a case where the UE is in RRC inactive mode. The UE 6-01 may include logMeasAvailable, logMeasAvailableBT, and logMeasAvailableWLAN in the RRC connection establishment complete message or RRC connection resumption complete message through the following procedure:
If the UE has logged measurements available for NR and if the registered public land mobile network (RPLMN) is included in plmn-IdentityList stored in VarLogMeasReport:
   include the logMeasAvailable in the RRCSetupComplete or RRCResumeComplete message;
   if Bluetooth measurement results are included in the logged measurements the UE has available for NR:
      include the logMeasAvailableBT in the RRCSetupComplete or RRCResumeComplete message;
   if WLAN measurement results are included in the logged measurements the UE has available for NR:
      include the logMeasAvailableWLAN in the RRCSetupComplete or RRCResumeComplete message.

In operation 6-40, the NR base station 6-02 may transmit a UE information request message (UEInformationRequest) to retrieve the logged measurement results from the UE 6-01. The UE information request message may include logMeasReportReq (for example, logMeasReportReq is set to true or is present).

In operation 6-45, the UE 6-01 may transmit a UE information response message (UEInformationResponse) to the NR base station 6-02 to report the logged measurement results. Specifically, the UE 6-01 may include the logged measurement results in the UE information response message through the procedure disclosed in Table 6 below.

```
TABLE 6
  Upon receiving the UEInformationRequest message, the UE shall, only
after successful security activation:
        1> if the logMeasReportReq is present and if the RPLMN is
  included in plmn-IdentityList stored in VarLogMeasReport:
          2> if VarLogMeasReport includes one or more logged
    measurement entries, set the contents of the logMeasReport in the
    UEInformationResponse message as follows:
            3> include the absoluteTimeStamp and set it to the value of
      absoluteTimeInfo in the VarLogMeasReport;
          3> include the traceReference and set it to the value of
    traceReference in the VarLogMeasReport;
            3> include the traceRecordingSessionRef and set it to the
      value of traceRecordingSessionRef in the VarLogMeasReport;
            3> include the tce-Id and set it to the value of tce-Id in the
      VarLogMeasReport;
            3> include the logMeasInfoList and set it to include one or
      more entries from the VarLogMeasReport starting from the entries
      logged first, and for each entry of the logMeasInfoList that is
      included, include all information stored in the corresponding
      logMeasInfoList entry in VarLogMeasReport;
            3> if the VarLogMeasReport includes one or more
      additional logged measurement entries that are not included in the
      logMeasInfoList within the UEInformationResponse message:
              4> include the logMeasAvailable;
              4> if bt-LocationInfo is included in locationInfo of
        one or more of the additional logged measurement entries in
        VarLogMeasReport that are not included in the logMeasInfoList
        within the UEInformationResponse message:
                5> include the logMeasAvailableBT;
              4> if wlan-LocationInfo is included in locationInfo
        of one or more of the additional logged measurement entries in
        VarLogMeasReport that are not included in the logMeasInfoList
        within the UEInformationResponse message:
                5> include the logMeasAvailableWLAN;
        1> if the logMeasReport is included in the
  UEInformationResponse:
          2> submit the UEInformationResponse message to lower
    layers for transmission via SRB2;
          2> discard the logged measurement entries included in the
    logMeasInfoList from VarLogMeasReport upon successful delivery
    of the UEInformationResponse message confirmed by lower layers;
        1> else:
          2> submit the UEInformationResponse message to lower
    layers for transmission via SRB1.
```

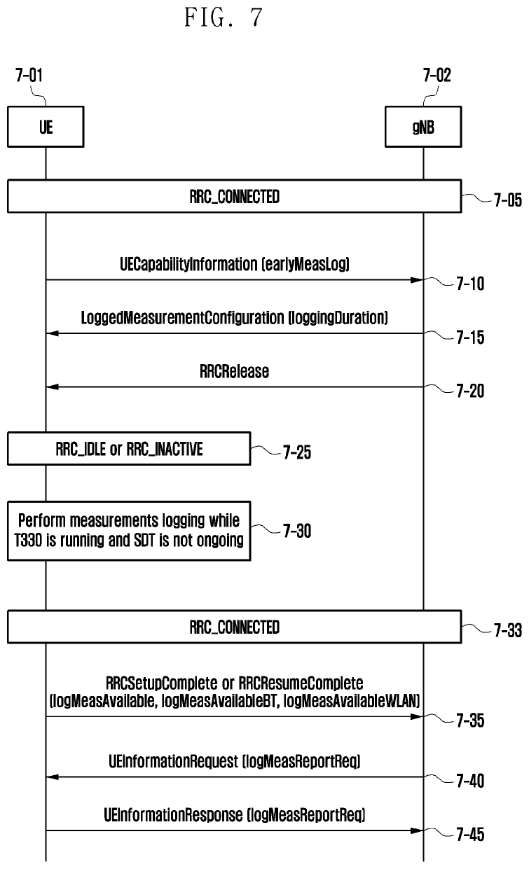

FIG. 7 illustrates a diagram of a logging procedure when a UE detects an in-device coexistence problem in an NR system according to an embodiment of the disclosure.

With reference to FIG. 7, a UE 7-01 may establish an RRC connection with an NR base station 7-02 and be in RRC connected mode 7-05.

In operation 7-10, the UE 7-01 may transmit a UE capability information message (UECapabilityInformation) to the NR base station 7-02 according to the above-described embodiment.

In operation 7-15, the NR base station 7-02 may transmit to the UE a logged measurement configuration message (LoggedMeasurementConfiguration) so that the UE 7-01 in RRC idle mode and RRC inactive mode logs the measurement results according to the above-described embodiment (perform logging of measurement results while in RRC_IDLE and RRC_INACTIVE). Upon receiving the logged measurement configuration message, the UE 7-01 may apply the logged measurement configuration message according to the above-described embodiment.

In operation 7-20, the NR base station 7-02 may transmit an RRC connection release message (RRCRelease) to the UE 7-01 according to the above-described embodiment in order to release the RRC connection with the UE 7-01.

In operation 7-25, the UE 7-01 may apply the received RRC connection release message and transition to the RRC idle mode or RRC inactive mode according to the above-described embodiment.

In operation 7-30, the UE 7-01 may perform measurement logging in a case where the T330 timer is running and small data transmission (SDT) is not in progress. For reference, the UE 7-01 runs the T330 timer in operation 7-15, and the T330 timer value may be set to loggingDuration included in the logged measurement configuration message received in operation 7-15. Specifically, the UE 7-01 may perform measurement logging according to the procedure of the above-described embodiment. An embodiment of the disclosure proposes that the UE 7-01 performs the following procedure in a case where the IDC problems are detected on at least one inter-RAT frequency (for example, LTE frequency) during the last logging interval, regardless of whether InterFreqTargetInfo (or interFreqTargetList) is configured:
In a case where the measurement results of a serving cell in the VarLogMeasReport is not empty (if measResultServingCell in the VarLogMeasReport is not empty), the UE may include inDeviceCoexDetected, and suspend measurement logging from the next logging interval (include inDeviceCoexDetected and suspend measurement logging from the next logging interval).
Otherwise, (for example, in a case where the measurement results of a serving cell in the VarLogMeasReport is empty), the UE may suspend measurement logging (suspend measurement logging).

For example, in a case where InterFreqTargetInfo (or interFreqTargetList) is configured differently from the above-described embodiment, the UE 7-01, according to an embodiment of the disclosure, may suspend measurement logging in a case where the IDC problems are detected at an inter-RAT (for example, LTE) frequency. It is apparent that, even if interFreqTargetInfo (or interFreqTargetList) is not configured, the UE 7-01 may suspend measurement logging even in a case where the IDC problems are detected at the inter-RAT frequency. Therefore, there is an advantage that the UE 7-01 does not report contaminated measurement results to the base station 7-02 when the IDC problems are detected at the inter-RAT frequency. For reference, the UE 7-01 may obtain the measurement results for the inter-RAT frequency through cell reselection or early measurement.

The UE 7-01 in RRC idle mode or RRC inactive mode may transition to RRC connected mode through the RRC connection establishment procedure or RRC connection resume procedure (7-33), and transmit an RRC connection establishment complete message (RRCSetupComplete) or RRC connection resumption complete message (RRCResumeComplete) (7-35) to the NR base station 7-02. Parameters included in the RRC connection establishment complete message or RRC connection resumption complete message may follow the above-described embodiment.

In operation 7-40, the NR base station 7-02 may transmit a UE information request message (UEInformationRequest) to retrieve the logged measurement results from the UE 7-01. The UE information request message may include logMeasReportReq (for example, logMeasReportReq is set to true or is present).

In operation 7-45, the UE 7-01 may transmit a UE information response message (UEInformationResponse) to the NR base station 7-02 to report the logged measurement results. This may follow the above-described embodiment.

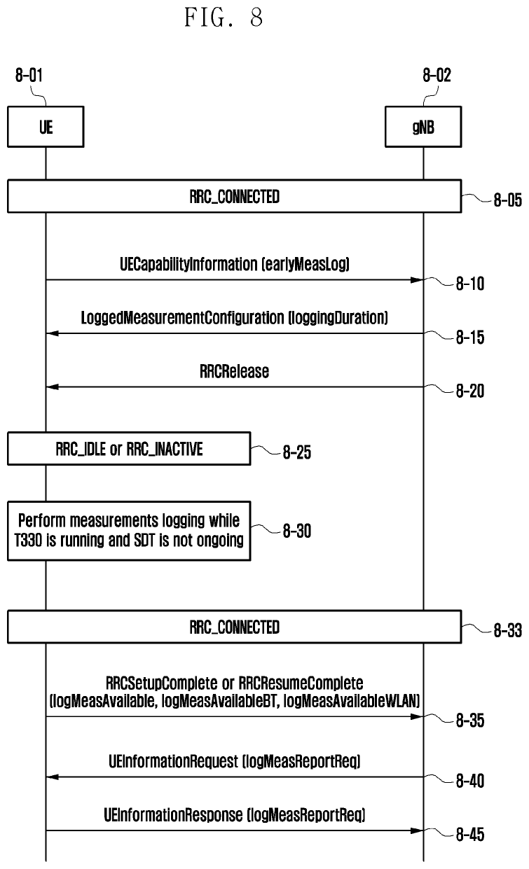

FIG. 8 illustrates a diagram of a logging procedure when a UE detects an in-device coexistence problem in an NR system according to an embodiment of the disclosure.

With reference to FIG. 8, the UE 8-01 may establish an RRC connection with an NR base station 8-02 and be in RRC connected mode (8-05).

In operation 8-10, the UE 8-01 may transmit a UE capability information message (UECapabilityInformation) to the NR base station 8-02 according to the above-described embodiment.

In operation 8-15, the NR base station 8-02 may transmit a logged measurement configuration message (LoggedMeasurementConfiguration) to the UE 8-01 so that the UE 8-01 in RRC idle mode and RRC inactive mode logs the measurement results (perform logging of measurement results while in RRC_IDLE and RRC_INACTIVE) according to the above embodiment. Upon receiving the logged measurement configuration message, the UE may apply the logged measurement configuration message according to the above-described embodiment.

In operation 8-20, the NR base station 8-02 may transmit an RRC connection release message (RRCRelease) to the UE 8-01 according to the above-described embodiment in order to release the RRC connection with the UE 8-01.

In operation 8-25, the UE 8-01 may apply the received RRC connection release message and transition to the RRC idle mode or RRC inactive mode according to the above-described embodiment.

In operation 8-30, the UE 8-01 may perform measurement logging in a case where the T330 timer is running and small data transmission (SDT) is not in progress. For reference, the UE runs the T330 timer in operation 8-15, and the T330 timer value is set to loggingDuration included in the logged measurement configuration message received in operation 8-15. Specifically, the UE 8-01 may perform measurement logging according to the procedure of the above-described embodiment. An embodiment of the disclosure proposes that the UE 8-01 performs the following procedure in a case where the IDC problems are detected on at least one NR frequency during the last logging interval:
In a case where the measurement result of a serving cell in the VarLogMeasReport is not empty (if measResultServingCell in the VarLogMeasReport is not empty), the UE may include inDeviceCoexDetected and suspend the measurement logging from the next logging interval (include inDeviceCoexDetected and suspend measurement logging from the next logging interval).
Otherwise (for example, in a case where the measurement result of a serving cell in the VarLogMeasReport is empty), the UE may suspend measurement logging (suspend measurement logging).

For example, in a case where InterFreqTargetInfo (or interFreqTargetList) is not configured, the UE 8-01, according to an embodiment of the disclosure, may be characterized in suspending measurement logging in a case where the IDC problems are detected at the NR frequency during the last logging interval. It is apparent that even if interFreqTargetInfo (or interFreqTargetList) is configured, the UE 8-01 is characterized in suspending measurement logging in a case where the IDC problems are detected at the NR frequency during the last logging interval. This is because the UE 8-01 includes inDeviceCoexDetected when there is the measurement result of the NR serving cell, so the base station 8-02 may effectively manage the logged measurement results if the UE 8-01 suspends measurement logging only in a case where the IDC problems are detected at the NR frequency.

The UE 8-01 in RRC idle mode or RRC inactive mode may transition to the RRC connected mode through the RRC connection establishment procedure or RRC connection resume procedure (8-33), and transmit an RRC connection establishment complete message (RRCSetupComplete) or RRC connection resumption complete message (RRCResumeComplete) to the NR base station 8-02 (8-35). Parameters included in the RRC connection establishment complete message or RRC connection resumption complete message may follow the above-described embodiment.

In operation 8-40, the NR base station 8-02 may transmit a UE information request message (UEInformationRequest) to retrieve the logged measurement results from the UE 8-01. The UE information request message may include logMeasReportReq (for example, logMeasReportReq is set to true or is present).

In operation 8-45, the UE 8-01 may transmit a terminal information response message (UEInformationResponse) to the NR base station 8-02 to report the logged measurement results. This may follow the above-described embodiment.

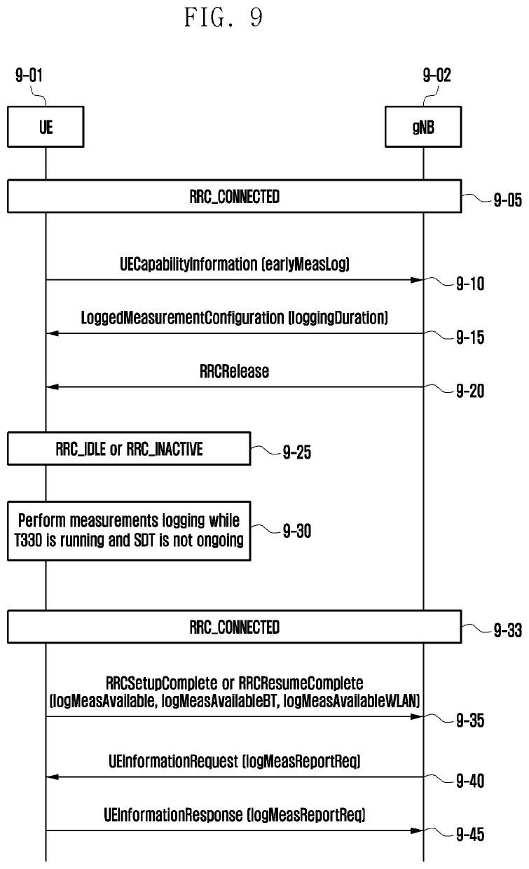

FIG. 9 illustrates a diagram of a logging procedure when a UE detects an in-device coexistence problem in an NR system according to an embodiment of the disclosure.

With reference to FIG. 9, a UE 9-01 may establish an RRC connection with an NR base station 9-02 and be in RRC connected mode (9-05).

In operation 9-10, the UE 9-01 may transmit a UE capability information message (UECapabilityInformation) to the NR base station 9-02 according to the above-described embodiment.

In operation 9-15, the NR base station 9-02 may transmit the logged measurement configuration message (LoggedMeasurementConfiguration) to the UE 9-01 so that the UE 9-01 in RRC idle mode or RRC inactive mode logs the measurement result (perform logging of measurement results while in RRC_IDLE and RRC_INACTIVE) according to the above-described embodiment. Upon receiving the logged measurement configuration message, the UE 9-01 may apply the logged measurement configuration message according to the above-described embodiment.

In operation 9-20, the NR base station 9-02 may transmit an RRC connection release message (RRCRelease) to the UE 9-01 according to the above-described embodiment in order to release the RRC connection with the UE 9-01.

In operation 9-25, the UE 9-01 may apply the received RRC connection release message and transition to the RRC idle mode or RRC inactive mode according to the above-described embodiment.

In operation 9-30, the UE 9-01 may perform measurement logging in a case where the T330 timer is running and small data transmission (SDT) is not in progress. For reference, the UE 9-01 runs the T330 timer in operation 9-15, and the T330 timer value may be set to loggingDuration included in the logged measurement configuration message received in operation 9-15. Specifically, the UE 9-01 may perform measurement logging according to the procedure of the above-described embodiment. The UE 9-01, according to an embodiment of the disclosure, may perform the following procedure when the IDC problem is detected at a predetermined frequency during the last logging:
In a case where the measurement result of a serving cell in the VarLogMeasReport is not empty (if measResultServingCell in the VarLogMeasReport is not empty), the UE may include inDeviceCoexDetected and suspend measurement logging from the next logging interval (include inDeviceCoexDetected and suspend measurement logging from the next logging interval).
Otherwise (for example, in a case where the measurement result of a serving cell in the VarLogMeasReport is empty), the UE may suspend measurement logging (suspend measurement logging).

The predetermined frequency may mean at least one of the following:
In a case where earlyMeasIndication is configured for the UE, inter-RAT frequency where the IDC problem is detected among the inter-RAT neighboring frequencies (or measurement results at the inter-RAT neighboring frequencies) included in measIdleCarrierListEUTRA in the VarMeasIdleConfig or SIB5.
In a case where earlyMeasIndication is not configured for the UE, inter-RAT frequencies where the IDC problem is detected among the inter-RAT neighboring frequencies included in the SIB5 (or measurement results at the inter-RAT neighboring frequencies).
In a case where both interFreqTargetInfo (or interFreqTargetList) and early MeasIndication are configured for the UE, NR neighboring frequency where the IDC problem is detected among the NR neighboring frequencies (or measurement results at the NR neighboring frequencies) included in measIdleCarrierListNR in the interFreqTargetInfo (or interFreqTargetList) and VarMeasIdleConfig.
In a case where both interFreqTargetInfo (or interFreqTargetList) and early MeasIndication are configured for the UE, NR neighboring frequency where the IDC problem is detected among the NR neighboring frequencies (or measurement results at the NR neighboring frequencies) included in the interFreqTargetInfo (or interFreqTargetList) and SIB4.
In a case where interFreqTargetInfo (or interFreqTargetList) is configured for the UE and earlyMeasIndication is not configured for the UE, NR neighboring frequency(s) where the IDC problem is detected among the NR neighboring frequencies (or measurement results at the NR neighboring frequencies) included in the interFreqTargetInfo (or interFreqTargetList) and SIB4.
In a case where interFreqTargetInfo (or interFreqTargetList) is not configured for the UE and earlyMeasIndication is configured for the UE, NR neighboring frequencies where the IDC problem is detected among the NR neighboring frequencies (or measurement results at the NR neighboring frequencies) included in measIdleCarrierListNR in the SIB4 or VarMeasIdleConfig.
In a case where neither interFreqTargetInfo (or interFreqTargetList) nor earlyMeasIndication is configured for the UE, NR neighboring frequency where the IDC problem is detected among the NR neighboring frequencies (or measurement results at the NR neighboring frequencies) included in the SIB4.
In a case where the IDC problem is detected at the serving NR frequency, i.e. intra NR frequency (or measurement results at the intra NR frequencies), serving NR frequency.

For example, the UE, according to an embodiment of the disclosure, may be characterized in suspending measurement logging in a case where the IDC problems are detected on at least one of the frequencies with actual measurement results. Alternatively, the UE, according to an embodiment of the disclosure, may be characterized in suspending measurement logging in a case where the IDC problems are detected at a frequency that logs (or will log) actual measurement results among the frequencies with actual measurement results. Therefore, there is an advantage that the base station may retrieve all accurate measurement results because the measurement logging is not suspended even if the IDC problems are detected at the frequencies that are not to be logged.

The UE 9-01 in RRC idle mode or RRC inactive mode may transition to the RRC connected mode through the RRC connection establishment procedure or RRC connection resume procedure (9-33), and transmit the RRC connection establishment complete message (RRCSetupComplete) or RRC connection resumption complete message (RRCResumeComplete) to the NR base station 9-02 (9-35). Parameters included in the RRC connection establishment complete message or RRC connection resumption complete message may follow the above-described embodiment.

In operation 9-40, the NR base station 9-02 may transmit a UE information request message (UEInformationRequest) to retrieve the logged measurement results from the UE 9-01. The UE information request message may include logMeasReportReq (for example, logMeasReportReq is set to true or is present).

In operation 9-45, the UE 9-01 may transmit a UE information response message (UEInformationResponse) to the NR base station 9-02 to report the logged measurement results. This may follow the above-described embodiment.

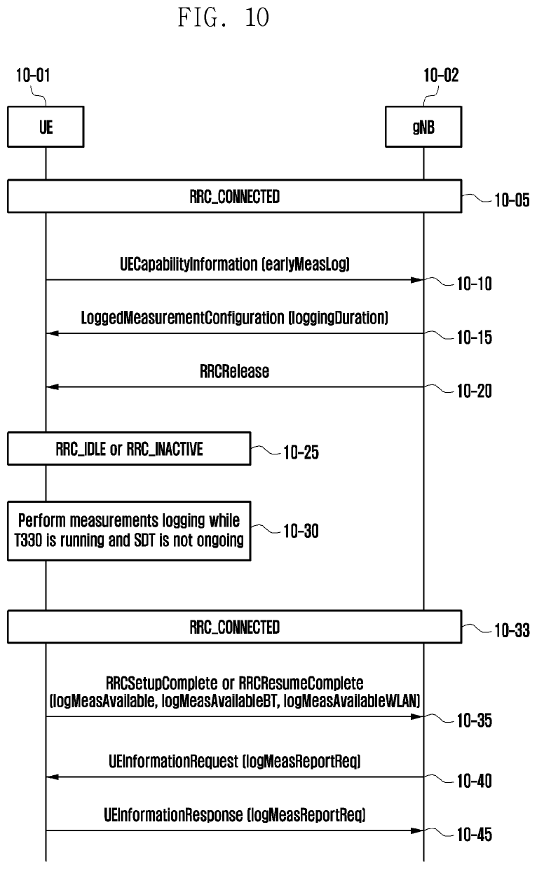

FIG. 10 illustrates a diagram for a logging procedure when a UE detects an in-device coexistence problem in an NR system according to an embodiment of the disclosure.

With reference to FIG. 10, a UE 10-01 may establish an RRC connection with an NR base station 10-02 and be in RRC connected mode (10-05).

In operation 10-10, the UE 10-01 may transmit a UE capability information message (UECapabilityInformation) to the NR base station 10-02 according to the above-described embodiment.

In operation 10-15, the NR base station 10-02 may transmit a logged measurement configuration message (LoggedMeasurementConfiguration) to the UE so that the UE 10-01 in RRC idle mode or RRC inactive mode performs logging of measurement results (perform logging of measurement results while in RRC_IDLE and RRC_INACTIVE) according to the above-described embodiment. Upon receiving the logged measurement configuration message, the UE may apply the logged measurement configuration message according to the above-described embodiment.

In operation 10-20, the NR base station 10-02 may transmit an RRC connection release message (RRCRelease) to the UE 10-01 according to the above-described embodiment to release the RRC connection with the UE 10-01.

In operation 10-25, the UE 10-01 may apply the received RRC connection release message and transition to the RRC idle mode or RRC inactive mode according to the above-described embodiment.

In operation 10-30, the UE 10-01 may perform measurement logging in a case where the T330 timer is running and small data transmission (SDT) is not in progress. For reference, the UE 10-01 runs the T330 timer in operation 10-15, and configures the T330 timer value to loggingDuration included in the logged measurement configuration message received in operation 10-15. Specifically, the UE 10-01 may perform measurement logging according to the procedure of the above-described embodiment. An embodiment of the disclosure proposes that in a case where the IDC problems are detected during the last logging, the UE 10-01 includes inDeviceCoexDetected in the VarLogMeasReport regardless of whether there is the measurement result of the serving cell, and suspends measurement logging from the next logging interval, according to the above-described embodiment. Alternatively, an embodiment of the disclosure proposes that the UE 10-01 includes only the inDeviceCoexDetected and relativeTimeStamp in the VarLogMeasReport regardless of whether there is the measurement result of the serving cell and suspends measurement logging from the next logging interval. Through this, there is an advantage that the base station 10-02 may explicitly identify information that the IDC problems have been detected even when the UE 10-01 does not have measurement results of the serving cell in a specific interval.

The UE 10-01 in RRC idle mode or RRC inactive mode may transition to the RRC connected mode through the RRC connection establishment procedure or RRC connection resume procedure (10-33), and transmit the RRC connection establishment complete message (RRCSetupComplete) or RRC connection resumption complete message (RRCResumeComplete) to the NR base station 10-02 (10-35). Parameters included in the RRC connection establishment complete message or RRC connection resumption complete message may follow the above-described embodiment.

In operation 10-40, the NR base station 10-02 may transmit a UE information request message (UEInformationRequest) to retrieve the logged measurement results from the UE 10-01. The UE information request message may include logMeasReportReq (i.e., logMeasReportReq is set to true or is present).

In operation 10-45, the UE 10-01 may transmit a UE information response message (UEInformationResponse) to the NR base station 10-02 to report the logged measurement results. This may follow the above-described embodiment.

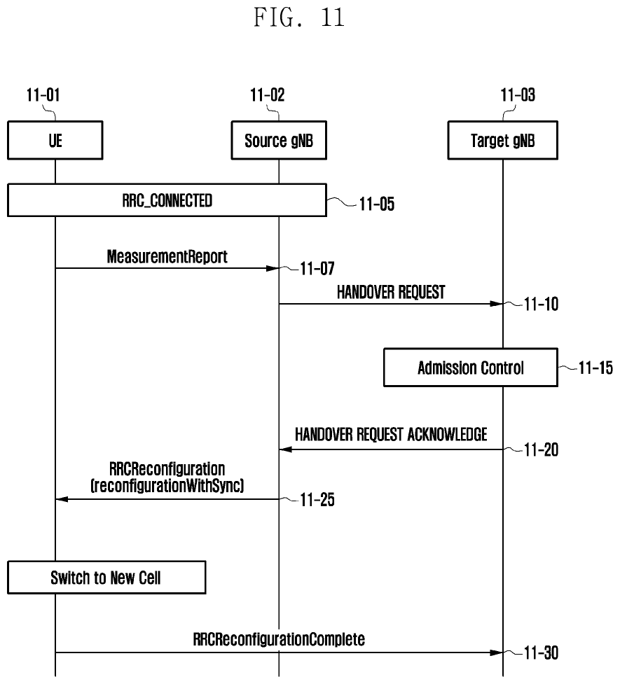

FIG. 11 illustrates a diagram of a procedure for a UE to successfully perform intra NR handover in an NR system according to an embodiment of the disclosure.

With reference to FIG. 11, a UE 11-01 may establish an RRC connection with a NR base station 11-02 and be in RRC connected mode (RRC_CONNECTED) (11-05). The NR base station 11-02 may provide measurement configuration information (measConfig) to the UE 11-01.

In operation 11-07, the UE 11-01 may transmit a measurement report message (MeasurementReport) including measurement results measured based on measurement configuration information to the NR base station 11-02.

In operation 11-10, the source NR base station 11-02 may transmit a handover request message (HANDOVER REQUEST) to the target NR base station 11-03 to initiate handover.

In operation 11-15, a target NR base station 11-03, that has received the handover request message, may perform admission control.

In operation 11-20, the target NR base station 11-03 may transmit a handover request acknowledgment message (HANDOVER REQUEST ACKNOWLEDGE) including new RRC configuration information to the source base station 11-02.

In operation 11-25, the source NR base station 11-02 may forward an RRC connection reconstitution message (RRCReconfiguration) included in the handover request acknowledgment message to the UE 11-01. For reference, the RRC connection reconstitution message may include information required to access at least target cell (for example, 11-03) and a Cell ID.

In operation 11-30, the UE 11-01 may successfully perform handover by changing the RRC connection to the target base station 11-03 and transmitting an RRC connection reconstitution complete message (RRCReconfigurationComplete).

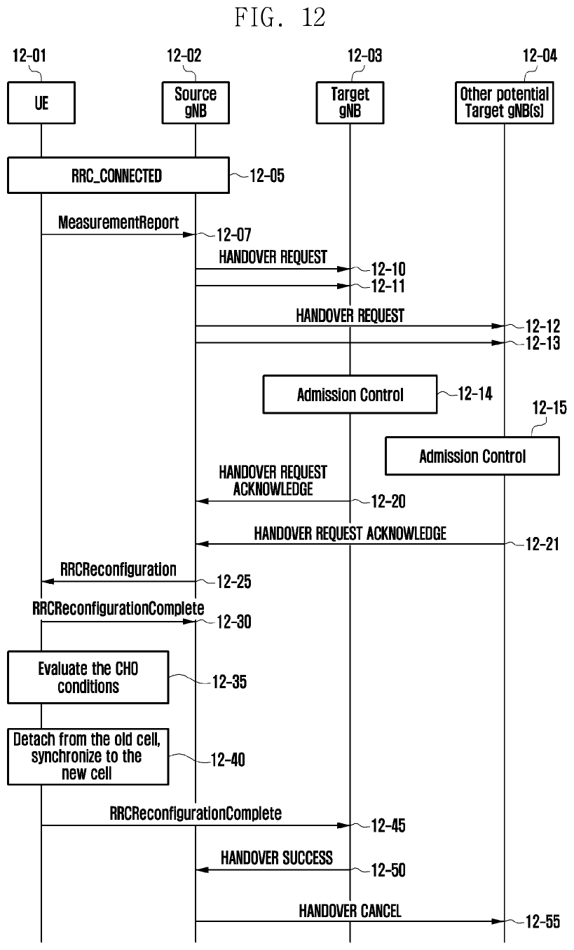

FIG. 12 illustrates a diagram for a procedure in which a UE successfully performs intra NR conditional handover (CHO) in an NR system according to an embodiment of the disclosure.

With reference to FIG. 12, a UE 12-01 may establish an RRC connection with an NR base station 12-02 and be in RRC connected mode (RRC_CONNECTED) (12-05). The NR base station 12-02 may provide measurement configuration information (measConfig) to the UE 12-01.

In operation 12-07, the UE 12-01 may transmit a measurement report message (MeasurementReport) including measurement results measured based on the measurement configuration information to the NR base station 12-02.

The source NR base station 12-02 may determine conditional handover (CHO). For example, the source NR base station 12-02 may request CHO for one or a plurality of candidate cells belonging to one or a plurality of candidate base stations 12-03, 12-04. As an example, the source NR base station 12-02 may transmit a CHO request message (HANDOVER REQUEST) to two candidate target cells belonging to each of the target NR base stations 12-03, 12-04 (12-10, 12-11, 12-12, 12-13). Each of the NR target base stations 12-03, 12-04, that has received the CHO request message, may perform admission control (12-14, 12-15). Each of the target NR base stations 12-03, 12-04 may transmit a CHO response message (HANDOVER REQUEST ACKNOWLEDGE) including configuration information of each CHO candidate cell to the source NR base station 12-02 (12-20, 12-21).

In operation 12-25, the source NR base station 12-02 may transmit an RRC connection reconstitution message (RRCReconfiguration) including the configuration information of CHO candidate cells and CHO execution condition to the UE 12-01. For example, the RRC connection reconstitution message includes a ConditionalReconfiguration information element, and specific configuration information for this may be as disclosed in Table 7 below.

TABLE 7

| | |
|---|---|
| ConditionalReconfiguration-r16 ::= | SEQUENCE { |
| attemptCondReconfig-r16 | ENUMERATED {true} |

OPTIONAL, -- Cond CHO

| | |
|---|---|
| condReconfigToRemoveList-r16 | CondReconfigToRemoveList- |

r16 OPTIONAL, -- Need N

| | |
|---|---|
| condReconfigToAddModList-r16 | CondReconfigToAddModList- |

```
r16 OPTIONAL, -- Need N
      ...
    }
```

| | |
|---|---|
| CondReconfigToRemoveList-r16 ::= | SEQUENCE (SIZE (1.. |

maxNrofCondCells-r16)) OF CondReconfigId-r16
CondReconfigToAddModList-r16 ::= SEQUENCE (SIZE (1..maxNrofCondCells-
r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |
| RRCReconfiguration) OPTIONAL, | -- Cond condReconfigAdd |

```
      ...,
      [[
```

| | |
|---|---|
| condExecutionCondSCG-r17 | OCTET STRING (CONTAINING |
| CondReconfigExecCondSCG-r17) OPTIONAL | -- Need M |

```
      ]]
    }
```

| | |
|---|---|
| CondReconfigExecCondSCG-r17 ::= | SEQUENCE (SIZE (1..2)) OF MeasId |

Descriptions for various fields set forth in Table 7 are provided in Tables 8 and 9 below.

TABLE 8
ConditionalReconfiguration field descriptions

attemptCondReconfig
If present, the UE shall perform conditional reconfiguration if selected cell
is a target candidate cell and it is the first cell selection after failure as
described in clause 5.3.7.3.
condReconfigToAddModList
List of the configuration of candidate SpCells to be added or modified for
CHO, CPA or CPC.
condReconfigToRemoveList
List of the configuration of candidate SpCells to be removed.

TABLE 9
CondReconfigToAddMod field descriptions

condExecutionCond
The execution condition that needs to be fulfilled in order to trigger the
execution of a conditional reconfiguration for CHO, CPA, intra-SN CPC without MN
involvement or MN initiated inter-SN CPC. When configuring 2 triggering events (Meas
Ids) for a candidate cell, network ensures that both refer to the same measObject. For
CHO, if network configures condEventD1 or condEventT1 for a candidate cell network
configures a second triggering event condEventA3, condEventA4 or condEventA5 for the
same candidate cell. Network does not configure both condEventD1 and condEventT1
for the same candidate cell.
condExecutionCondSCG
Contains execution condition that needs to be fulfilled in order to trigger the
execution of a conditional reconfiguration for SN initiated inter-SN CPC. The Meas Ids
refer to the measConfig associated with the SCG. When configuring 2 triggering events
(Meas Ids) for a candidate cell, network ensures that both refer to the same
measObject. For each condReconfigId, the network always configures either
condExecutionCond or condExecutionCondSCG (not both).
condRRCReconfig
The RRCReconfiguration message to be applied when the condition(s) are
fulfilled. The RRCReconfiguration message contained in condRRCReconfig cannot
contain the field conditionalReconfiguration or the field daps-Config.

In operation 12-30, the UE 12-01 may transmit an RRC connection reconstitution complete message (RRCReconfigurationComplete) to the source NR base station 12-02. Herein, the UE 12-01 may maintain an RRC connection with the source NR base station 12-02. The UE 12-01 may store the CHO configuration information and CHO execution conditions received in operation 12-25.

In operation 12-35, the UE 12-01 may start evaluating the CHO execution conditions for the candidate target cells (starts evaluating the CHO execution conditions for the candidate cell(s)).

In operation 12-40, the UE 12-01 may detach from the source NR base station 12-02 in a case where the CHO execution condition is satisfied in at least one CHO target cell. Further, the UE 12-01 may synchronize with the target cell by applying the stored configuration for the selected target cell (apply the stored condRRCReconfig of the selected cell). Specifically, the UE may perform the procedures disclosed in Table 10 below.

```
TABLE 10
      1> if the RRCReconfiguration is applied due to a conditional
reconfiguration execution upon cell selection performed while timer T311
was running, as defined in 5.3.7.3:
        2> remove all the entries within the MCG and the SCG
  VarConditionalReconfig, if any;
      1> if the RRCReconfiguration includes the daps-SourceRelease:
        2> reset the source MAC and release the source MAC
  configuration;
        2> for each DAPS bearer:
          3> release the RLC entity or entities as specified in TS 38.322
    [4], clause 5.1.3, and the associated logical channel for the source
    SpCell;
          3> reconfigure the PDCP entity to release DAPS as specified
    in TS 38.323 [5];
        2> for each SRB:
          3> release the PDCP entity for the source SpCell;
          3> release the RLC entity as specified in TS 38.322 [4], clause
    5.1.3, and the associated logical channel for the source SpCell;
        2> release the physical channel configuration for the source
  SpCell;
        2> discard the keys used in the source SpCell (the K_{gNB} key,
  the K_{RRCenc} key, the K_{RRCint} key, the K_{UPint} key and the K_{UPenc} key), if
  any;
      1> if the RRCReconfiguration is received via other RAT (i.e.,
inter-RAT handover to NR):
        2> if the RRCReconfiguration does not include the fullConfig
  and the UE is connected to 5GC (i.e., delta signalling during intra 5GC
  handover):
          3> re-use the source RAT SDAP and PDCP configurations if
    available (i.e., current SDAP/PDCP configurations for all RBs from
    source E-UTRA RAT prior to the reception of the inter-RAT HO
    RRCReconfiguration message);
      1>  else:
        2>  if the RRCReconfiguration includes the fullConfig:
          3> perform the full configuration procedure as specified in
    5.3.5.11;
      1>  if the RRCReconfiguration includes the masterCellGroup:
        2>  perform the cell group configuration for the received
  masterCellGroup according to 5.3.5.5;
      1>  if the RRCReconfiguration includes the masterKeyUpdate:
        2>  perform AS security key update procedure as specified in
  5.3.5.7;
      1>  if the RRCReconfiguration includes the sk-Counter:
        2>  perform security key update procedure as specified in
        5.3.5.7;
      1> if the RRCReconfiguration includes the secondaryCellGroup:
        2>  perform the cell group configuration for the SCG according
  to 5.3.5.5;
      1>  if the RRCReconfiguration includes the mrdc-
SecondaryCellGroupConfig:
        2>  if the mrdc-SecondaryCellGroupConfig is set to setup:
          3> if the mrdc-SecondaryCellGroupConfig includes mrdc-
    ReleaseAndAdd:
            4>  perform MR-DC release as specified in clause
            5.3.5.10;
          3> if the received mrdc-SecondaryCellGroup is set to nr-SCG:
            4>  perform the RRC reconfiguration according to
      5.3.5.3 for the RRCReconfiguration message included in nr-SCG;
          3> if the received mrdc-SecondaryCellGroup is set to eutra-
          SCG:
            4>  perform the RRC connection reconfiguration as
      specified in TS 36.331 [10], clause 5.3.5.3 for the
      RRCConnectionReconfiguration message included in eutra-SCG;
        2>  else (mrdc-SecondaryCellGroupConfig is set to release):
          3> perform MR-DC release as specified in clause 5.3.5.10;
      1>  if the RRCReconfiguration message includes the
radioBearerConfig:
        2>  perform the radio bearer configuration according to 5.3.5.6;
      1>  if the RRCReconfiguration message includes the
radioBearerConfig2:
        2>  perform the radio bearer configuration according to 5.3.5.6;
      1>  if the RRCReconfiguration message includes the
      measConfig:
        2>  perform the measurement configuration procedure as
  specified in 5.5.2;
      1>  if the RRCReconfiguration message includes the
dedicatedNAS-MessageList:
        2>  forward each element of the dedicatedNAS-MessageList to
  upper layers in the same order as listed;
      1>  if the RRCReconfiguration message includes the
dedicatedSIB1-Delivery:
        2>  perform the action upon reception of SIB1 as specified in
  5.2.2.4.2;
        NOTE 0:  If this RRCReconfiguration is associated to the
    MCG and includes reconfigurationWithSync in spCellConfig and
    dedicatedSIB1-Delivery, the UE initiates (if needed) the request to
    acquire required SIBs, according to clause 5.2.2.3.5, only after the
    random access procedure towards the target SpCell is completed.
      1>  if the RRCReconfiguration message includes the
dedicatedSystemInformationDelivery:
        2>  perform the action upon reception of System Information
  as specified in 5.2.2.4;
      1>  if the RRCReconfiguration message includes the
      otherConfig:
        2>  perform the other configuration procedure as specified in
  5.3.5.9;
      1>  if the RRCReconfiguration message includes the
conditionalReconfiguration:
    2> perform conditional reconfiguration as specified in 5.3.5.13;
      1>  set the content of the RRCReconfigurationComplete
message as follows:
        2>  if the RRCReconfiguration includes the
  reconfigurationWithSync in spCellConfig of an MCG:
          3> if the UE has logged measurements available for NR and
    if the RPLMN is included in plmn-IdentityList stored in
VarLogMeasReport:
            4> include the logMeasAvailable in the
      RRCReconfigurationComplete message;
            4> if Bluetooth measurement results are included in
      the logged measurements the UE has available for NR:
              5> include the logMeasAvailableBT in the
        RRCReconfigurationComplete message;
            4> if WLAN measurement results are included in the
      logged measurements the UE has available for NR:
              5> include the logMeasAvailableWLAN in the
        RRCReconfigurationComplete message;
          3> if the sigLoggedMeas Type in VarLogMeasReport is
          included:
            4> if T330 timer is running and the logged
      measurements configuration is for NR:
              5> set sigLogMeasConfigAvailable to true in the
        RRCReconfigurationComplete message;
            4> else:
              5> if the UE has logged measurements available for
              NR:
                6> set sigLogMeasConfigAvailable to false in the
          RRCReconfigurationComplete message;
          3> if the UE has connection establishment failure or
    connection resume failure information available in
    VarConnEstFailReport or VarConnEstFailReportList and if the
    RPLMN is equal to plmn-Identity stored in VarConnEstFailReport
    or in at least one of the entries of VarConnEstFailReportList:
            4> include connEstFailInfoAvailable in the
      RRCReconfigurationComplete message;
          3> if the UE has radio link failure or handover failure
    information available in VarRLF-Report and if the RPLMN is
    included in plmn-IdentityList stored in VarRLF-Report; or
          3> if the UE has radio link failure or handover failure
    information available in VarRLF-Report of TS 36.331 [10] and if
    the UE is capable of cross-RAT RLF reporting and if the RPLMN
    is included in plmn-IdentityList stored in VarRLF-Report of TS
    36.331 [10]:
            4> include rlf-InfoAvailable in the
      RRCReconfigurationComplete message;
          3> if the UE was configured with successHO-Config when
    connected to the source PCell; and
          3> if the applied RRCReconfiguration is not due to a
    conditional reconfiguration execution upon cell selection performed
    while timer T311 was running, as defined in 5.3.7.3:
            4> perform the actions for the successful handover
      report determination as specified in clause 5.7.10.6, upon
      successfully completing the Random Access procedure triggered
      for the reconfigurationWithSync in spCellConfig of the MCG;
          3> if the UE has successful handover information available in
    VarSuccessHO-Report and if the RPLMN is included in plmn-
    IdentityList stored in VarSuccessHO-Report:
            4> include successHO-InfoAvailable in the
      RRCReconfigurationComplete message;
      1> else (RRCReconfiguration was received via SRB1):
        2> if the UE is in NR-DC and;
        2> if the RRCReconfiguration does not include the mrdc-
  SecondaryCellGroupConfig:
          3> if the RRCReconfiguration includes the scg-State:
            4> perform SCG deactivation as specified in 5.3.5.13b;
          3> else:
            4> perform SCG activation without SN message as
      specified in 5.3.5.13b1;
        2> submit the RRCReconfigurationComplete message via
  SRB1 to lower layers for transmission using the new configuration;
        2> if this is the first RRCReconfiguration message after
  successful completion of the RRC re-establishment procedure:
          3> resume SRB2, SRB4, DRBs, multicast MRB, and BH RLC
    channels for IAB-MT, that are suspended;
      1> if reconfigurationWithSync was included in spCellConfig
of an MCG or SCG and when MAC of an NR cell group successfully
completes a Random Access procedure triggered above; or,
        2> stop timer T304 for that cell group if running;
        2> stop timer T310 for source SpCell if running;
        2>  apply the parts of the CSI reporting configuration, the
  scheduling request configuration and the sounding RS configuration
  that do not require the UE to know the SFN of the respective target
  SpCell, if any;
        2>  apply the parts of the measurement and the radio resource
  configuration that require the UE to know the SFN of the respective
  target SpCell (e.g. measurement gaps, periodic CQI reporting,
  scheduling request configuration, sounding RS configuration), if any,
  upon acquiring the SFN of that target SpCell;
        2>  for each DRB configured as DAPS bearer, request uplink
  data switching to the PDCP entity, as specified in TS 38.323 [5];
        2>  if the reconfigurationWithSync was included in
  spCellConfig of an MCG:
          3> if T390 is running:
            4> stop timer T390 for all access categories;
            4> perform the actions as specified in 5.3.14.4.
          3> if T350 is running:
            4>  stop timer T350;
          3> if RRCReconfiguration does not include dedicatedSIB1-
    Delivery and
          3> if the active downlink BWP, which is indicated by the
    firstActiveDownlinkBWP-Id for the target SpCell of the MCG, has a
    common search space configured by searchSpaceSIB1:
            4>  acquire the SIB1, which is scheduled as specified in
      TS 38.213 [13], of the target SpCell of the MCG;
            4> upon acquiring SIB1, perform the actions specified
      in clause 5.2.2.4.2;
        2> if the reconfigurationWithSync was included in
  spCellConfig of an MCG; or
        2> if the reconfigurationWithSync was included in
  spCellConfig of an SCG and the CPA or CPC was configured:
          3> remove all the entries within the MCG and the SCG
    VarConditionalReconfig, if any;
          3> remove all the entries within
    VarConditionalReconfiguration as specified in TS 36.331 [10],
    clause 5.3.5.9.6, if any;
        3> for each measId of the MCG measConfig, if configured, and
    for each measId of the SCG measConfig, if configured, if the
    associated reportConfig has a reportType set to condTriggerConfig:
            4> for the associated reportConfigId:
              5> remove the entry with the matching reportConfigId
        from the reportConfigList within the VarMeasConfig;
            4> if the associated measObjectId is only associated to
      a reportConfig with reportType set to condTriggerConfig:
              5> remove the entry with the matching measObjectId
        from the measObjectList within the VarMeasConfig;
            4> remove the entry with the matching measId from the
      measIdList within the VarMeasConfig;
```

In operation 12-45, the UE 12-01 may successfully perform CHO by transmitting an RRC connection reconstitution complete message to the target NR base station 12-03. The UE 12-01 may release the stored CHO configuration information after the RRC handover procedure is successfully completed.

In operation 12-50, the target NR base station 12-03 may transmit a handover success message (HANDOVER SUCCESS) to the source NR base station 12-02 to inform that the UE 12-01 has successfully accessed the target cell.

In operation 12-55, the source NR base station 12-02 may transmit a handover cancellation message (HANDOVER CANCEL) to other signaling connections or other candidate target NR base stations 12-04 to cancel CHO for the terminal 12-01.

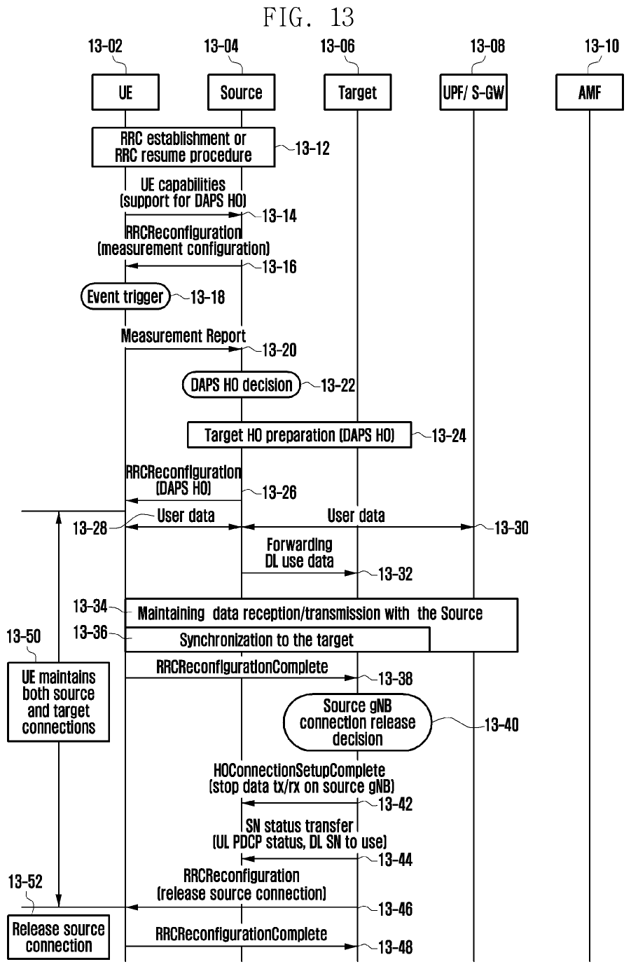

FIG. 13 illustrates a flowchart of a process in which a UE performs DAPS handover with a base station according to an embodiment of the disclosure.

A UE 13-02 may switch to connected mode with a source base station 13-04 through an RRC establishment or RRC resume process (13-12).

A UE 13-02 capable of supporting DAPS handover may report to the source base station 13-04 that it supports DAPS handover (13-14).

The source base station 13-04 may configure a measurement configuration for the UE 13-02 using an RRC connection reconstitution message (RRCReconfiguration) for the purpose of mobility support (13-16).

When a measurement report event is triggered (13-18), the UE 13-02 may report a measurement report message (MeasurementReport) to the source base station 13-04 (13-20).

The source base station 13-04, that has received the measurement report message, may determine to perform DAPS handover with a specific neighboring base station based on the cell measurement information included in the measurement report message (13-22). In addition, the source base station 13-04 may transmit a handover request message to the target base station 13-06. The target base station 13-06 may transmit a response message to the handover request message to the source base station 13-24. The handover request message may include an indicator indicating that the UE 13-02 will perform DAPS handover. The response message may include handover configuration information or additional configuration information for the UE 13-02.

The source base station 13-04 may store the handover configuration information or additional configuration information received from the target base station 13-06 in a predetermined RRC message and transmit the RRC connection reconstitution message to the UE 13-02 (13-26). The handover configuration information may include a target cell ID, frequency information, configuration information required for random access action to the target cell (dedicated preamble information, dedicated radio resource information, etc.), transmission power information, C-RNTI information used in the target cell, a T304 timer value, a T304-like timer value, or the like. The UE 13-02, that has received the handover configuration information, may run the T304 or T304-like timer and perform random access to the target cell (13-36).

When the timer expires, if the RRC connection reconstitution message is not successfully transmitted to the target cell, the handover may be considered failed. In a case where the handover is considered to have failed, the UE 13-02 may reapply the configuration information used in the source cell or source base station (revert back to the configuration used in the source PCell/base station). In this case, data may be continuously transmitted and received with the source base station without initiating an RRC connection re-establishment procedure with the source cell.

In operation 13-26, some of the system information broadcast by the target cell may be included in the RRC connection reconstitution message.

In operation 13-26, the RRC connection reconstitution message may include an indicator indicating that this is a handover using DAPS. The UE 13-02, that has received the indicator, may maintain data transmission and reception with the source cell until a predetermined time even after transmitting a first preamble to the target cell (13-28, 13-34). The UE's user data transmitted and received through the source cell may be delivered to an end user through UPF/S-WG 13-08 (13-30). The source cell may forward the downlink data of the UE to the target cell (13-32). This is because the signal quality of the link with the source cell may rapidly deteriorate, making it difficult to transmit and receive data.

In a case where the UE 13-02 receives a random access response message from the target cell, it may transmit an RRC connection reconstitution complete message to the target cell (13-38). If the RRC message is successfully transmitted, it means that handover to the target cell has been successfully completed. The UE 13-02 performs uplink data transmission with the source cell until the RRC message is successfully transmitted.

When the UE 13-02 receives a UL grant (uplink scheduling information) from the target cell, it may switch uplink to the target cell. The target cell, that has received the RRC connection reconstitution complete message, may determine to release the connection between the UE and the source cell (13-40).

The target base station 13-06 may request the source base station 13-04 to release the above connection (13-42). The source base station 13-04, that has received the above request, may stop transmitting and receiving data to and from the UE 13-02. The source base station 13-02 may provide SN status transfer to the target base station 13-04 (13-44). The information may be used to smoothly transmit and receive data from the target base station 13-04 to the UE. The target base station 13-04 may instruct the UE to release the connection with the source cell using a predetermined RRC message (13-46). The UE, that has received the message, may release the connection with the source cell (13-52) and transmit a response message to the message (13-48). As another option, the UE 13-02 may implicitly release the connection with the source base station 13-02 at the point when the UE 13-02 successfully transmits the RRC connection reconstitution complete message to the target base station 13-04 or after a predetermined offset time.

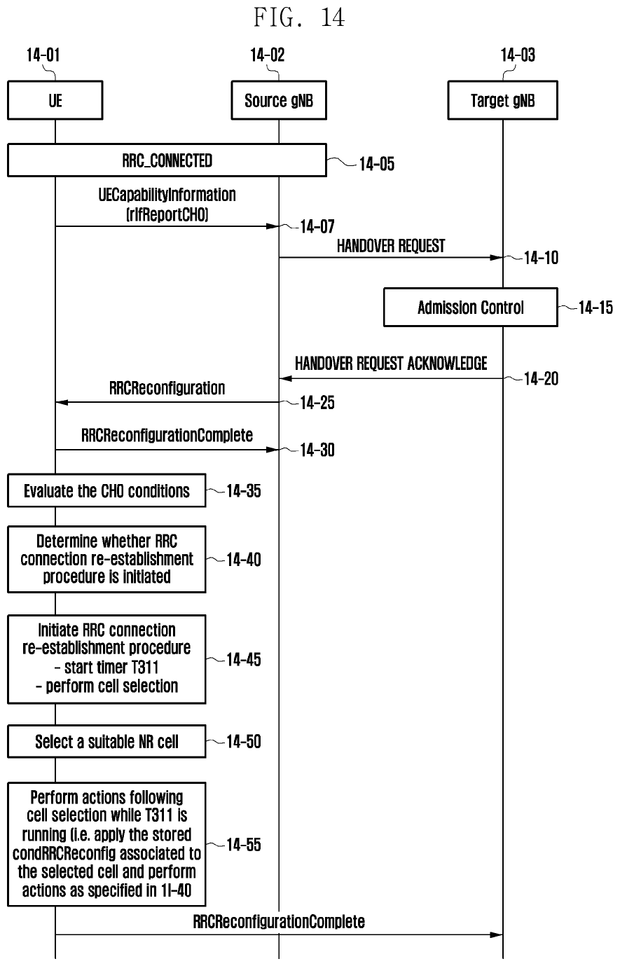

FIG. 14 illustrates a flowchart of a process in which a UE maintains an RRC connection to a CHO recovery cell through conditional handover (CHO) during an RRC connection re-establishment procedure according to an embodiment of the disclosure.

With reference to FIG. 14, a UE 14-01 may establish an RRC connection with an NR base station 14-02 and be in RRC connected mode (RRC_CONNECTED) (14-05).

In operation 14-07, the UE 14-01 may transmit a UE capability information message (UECapability Information) to the NR base station 14-02. The UE capability information message may include an indicator (rlfReportCHO) indicating whether RLF-Report for CHO is supported.

In operation 14-10, the source NR base station 14-02 determines conditional handover (CHO) and may transmit a CHO request message (HANDOVERREQUEST) to request CHO for one or a plurality of candidate cells belonging to a specific candidate target NR base station 14-03. In an embodiment of the disclosure, for convenience of explanation, it is assumed that a CHO request message is transmitted for one candidate cell, and the rest may follow the above-described embodiment.

In operation 14-15, the specific candidate target NR base station 14-03, that has received the CHO request message, may perform admission control.

In operation 14-20, the specific candidate NR target base station 14-03 may transmit a CHO response message (HANDOVER REQUEST ACKNOWLEDGE) including configuration information of each CHO candidate cell to the source NR base station 14-02. This may follow the above-described embodiment.

In operation 14-25, the source NR base station 14-02 may transmit an RRC connection reconstitution message (RRCReconfiguration) including the configuration information of CHO candidate cells and CHO execution conditions to the UE 14-01.

In operation 14-30, the UE 14-01 may transmit the RRC connection reconstitution complete message (RRCReconfigurationComplete) to the source NR base station 14-02. In this case, the UE 14-01 may maintain an RRC connection with the source NR base station 14-02. The UE 14-01 may store the CHO configuration information and CHO execution conditions received in operation 14-25.

In operation 14-35, the UE 14-01 may start evaluating the CHO execution conditions for the candidate target cells (starts evaluating the CHO execution conditions for the candidate cell(s)).

In operation 14-40, the UE 14-01 may determine whether at least one of the conditions disclosed in Table 11 below is satisfied.

TABLE 11
upon detecting radio link failure of the MCG and t316 is not
configured, in accordance with 5.3.10; or
upon detecting radio link failure of the MCG while SCG
transmission is suspended, in accordance with 5.3.10; or
upon detecting radio link failure of the MCG while PSCell change or
PSCell addition is ongoing, in accordance with 5.3.10; or
upon detecting radio link failure of the MCG while the SCG is
deactivated, in accordance with 5.3.10; or
upon re-configuration with sync failure of the MCG, in accordance
with clause 5.3.5.8.3; or
upon mobility from NR failure, in accordance with clause 5.4.3.5; or
upon integrity check failure indication from lower layers concerning
SRB1 or SRB2, except if the integrity check failure is detected on the
RRCReestablishment message; or
upon an RRC connection reconfiguration failure, in accordance with
clause 5.3.5.8.2; or
upon detecting radio link failure for the SCG while MCG
transmission is suspended, in accordance with clause 5.3.10.3 in NR-DC or
in accordance with TS 36.331 [10] clause 5.3.11.3 in NE-DC; or
upon reconfiguration with sync failure of the SCG while MCG
transmission is suspended in accordance with clause 5.3.5.8.3; or
upon SCG change failure while MCG transmission is suspended in
accordance with TS 36.331 [10] clause 5.3.5.7a; or
upon SCG configuration failure while MCG transmission is
suspended in accordance with clause 5.3.5.8.2 in NR-DC or in accordance
with TS 36.331 [10] clause 5.3.5.5 in NE-DC; or
upon integrity check failure indication from SCG lower layers
concerning SRB3 while MCG is suspended; or
upon T316 expiry, in accordance with clause 5.7.3b.5; or
upon detecting sidelink radio link failure by L2 U2N Remote UE in
RRC_CONNECTED, in accordance with clause 5.8.9.3; or
upon reception of NotificationMessageSidelink including
indication Type by L2 U2N Remote UE in RRC_CONNECTED, in
accordance with clause 5.8.9.10; or
upon PC5 unicast link release indicated by upper layer at L2 U2N
Remote UE in RRC_CONNECTED

In operation 14-45, the UE 14-01 determines that at least one of the conditions described above in operation 14-40 is satisfied, and may initiate an RRC connection re-establishment procedure. When initiating the RRC connection re-establishment procedure, the UE 14-01 may run the T311 timer and then perform cell selection through the cell selection process specified in 3GPP TS 38.304. For reference, the specific procedure performed by the UE 14-01 when initiating the RRC connection re-establishment procedure may be the same as the procedure disclosed in Table 12 below.

TABLE 12

| 1> | stop timer T310, if running; |
|---|---|
| 1> | stop timer T312, if running; |
| 1> | stop timer T304, if running; |
| 1> | start timer T311; |
| 1> | stop timer T316, if running; |
| 1> | if UE is not configured with attemptCondReconfig: |
| 2> | reset MAC; |
| 2> | release spCellConfig, if configured; |
| 2> | suspend all RBs, and BH RLC channels for IAB-MT, and Uu |
| Relay RLC channels for L2 U2N Relay UE, except SRB0 and broadcast | |
| MRBs; | |
| 2> | release the MCG SCell(s), if configured; |
| 2> | if MR-DC is configured: |
| 3> | perform MR-DC release, as specified in clause 5.3.5.10; |
| 2> | release delayBudgetReportingConfig, if configured and stop |
| timer T342, if running; | |
| 2> | release overheatingAssistanceConfig, if configured and stop |
| timer T345, if running; | |
| 2> | release idc-AssistanceConfig, if configured; |
| 2> | release btNameList, if configured; |
| 2> | release wlanNameList, if configured; |
| 2> | release sensorNameList, if configured; |
| 2> | release drx-PreferenceConfig for the MCG, if configured and |
| stop timer T346a associated with the MCG, if running; | |
| 2> | release maxBW-PreferenceConfig for the MCG, if configured |
| and stop timer T346b associated with the MCG, if running; | |
| 2> | release maxCC-PreferenceConfig for the MCG, if configured |
| and stop timer T346c associated with the MCG, if running; | |
| 2> | release maxMIMO-LayerPreferenceConfig for the MCG, if |
| configured and stop timer T346d associated with the MCG, if running; | |
| 2> | release minSchedulingOffsetPreferenceConfig for the MCG, |
| if configured stop timer T346e associated with the MCG, if running; | |
| 2> | release rlm-RelaxationReportingConfig for the MCG, if |
| configured and stop timer T346j associated with the MCG, if running; | |
| 2> | release bfd-RelaxationReportingConfig for the MCG, if |
| configured and stop timer T346k associated with the MCG, if running; | |
| 2> | release releasePreferenceConfig, if configured stop timer |
| T346f, if running; | |
| 2> | release onDemandSIB-Request if configured, and stop timer |
| T350, if running; | |
| 2> | release referenceTimePreferenceReporting, if configured; |
| 2> | release sl-AssistanceConfigNR, if configured; |
| 2> | release obtainCommonLocation, if configured; |
| 2> | release musim-GapAssistanceConfig, if configured and stop |
| timer T346h, if running; | |
| 2> | release musim-LeaveAssistanceConfig, if configured; |
| 2> | release ul-GapFR2-PreferenceConfig, if configured; |
| 2> | release scg-DeactivationPreferenceConfig, if configured, and |
| stop timer T346i, if running; | |
| 2> | release propDelayDiffReportConfig, if configured; |
| 2> | release rrm-MeasRelaxationReportingConfig, if configured; |
| 2> | release maxBW-PreferenceConfigFR2-2, if configured; |
| 2> | release maxMIMO-LayerPreferenceConfigFR2-2, if |
| configured; | |
| 2> | release minSchedulingOffsetPreferenceConfigExt, if |
| configured; | |
| 1> | release successHO-Config, if configured; |
| 1> | if any DAPS bearer is configured: |
| 2> | reset the source MAC and release the source MAC |
| configuration; | |
| 2> | for each DAPS bearer: |
| 3> | release the RLC entity or entities as specified in TS 38.322 |
| [4], clause 5.1.3, and the associated logical channel for the source | |
| SpCell; | |
| 3> | reconfigure the PDCP entity to release DAPS as specified in |
| TS 38.323 [5]; | |
| 2> | for each SRB: |
| 3> | release the PDCP entity for the source SpCell; |
| 3> | release the RLC entity as specified in TS 38.322 [4], clause |
| 5.1.3, and the associated logical channel for the source SpCell; | |
| 2> | release the physical channel configuration for the source |
| SpCell; | |
| 2> | discard the keys used in the source SpCell (the K_{gNB} key, the |
| K_{RRCenc} key, the K_{RRCint} key, the K_{UPint} key and the K_{UPenc} key), if any; | |
| 1> | release sl-L2RelayUE-Config, if configured; |
| 1> | release sl-L2RemoteUE-Config, if configured; |
| 1> | release the SRAP entity, if configured; |
| 1> | if the UE is acting as L2 U2N Remote UE: |
| 2> | if the PC5-RRC connection with the U2N Relay UE is |
| determined to be released: | |
| 3> | indicate upper layers to trigger PC5 unicast link release; |
| 3> | perform either cell selection in accordance with the cell |
| selection process as specified in TS 38.304 [20], or relay selection as | |
| specified in clause 5.8.15.3, or both; | |
| 2> | else (i.e., maintain the PC5 RRC connection): |
| 3> | consider the connected L2 U2N Relay UE as suitable and |
| perform actions as specified in clause 5.3.7.3a; | |
| | NOTE 1: It is up to Remote UE implementation whether to |
| release or keep the current PC5 unicast link. | |
| 1> | else: |
| 2> | perform cell selection in accordance with the cell selection |

process as specified in TS 38.304 [20].

In operation 14-50, the UE 14-01 may select a suitable NR cell. For reference, the definition of a suitable NR cell may be a suitable cell specified in 3GPP TS 38.304. A suitable NR cell according to an embodiment may be as disclosed in Table 13 below.

```
TABLE 13
    suitable cell:
    For UE not operating in SNPN Access Mode, a cell is considered as
suitable if the following conditions are fulfilled:
      - The cell is part of either the selected PLMN or the registered PLMN
  or PLMN of the Equivalent PLMN list, and for that PLMN either:
        - The PLMN-ID of that PLMN is broadcast by the cell with no
    associated CAG-IDs and CAG-only indication in the UE for that PLMN (TS
    23.501 [10]) is absent or false;
        - Allowed CAG list in the UE for that PLMN (TS 23.501 [10])
    includes a CAG-ID broadcast by the cell for that PLMN;
      - The cell selection criteria are fulfilled, see clause 5.2.3.2.
    According to the latest information provided by NAS:
      - The cell is not barred, see clause 5.3.1;
      - The cell is part of at least one TA that is not part of the list of
  “Forbidden Tracking Areas for Roaming” (TS 22.011 [18]), which belongs to a
  PLMN that fulfils the first bullet above.
    For UE operating in SNPN Access Mode, a cell is considered as suitable if
the following conditions are fulfilled:
      - The cell is part of either the selected SNPN or the registered SNPN
  of the UE;
      - The cell selection criteria are fulfilled, see clause 5.2.3.2;
    According to the latest information provided by NAS:
      - The cell is not barred, see clause 5.3.1;
      - The cell is part of at least one TA that is not part of the list of
  “Forbidden Tracking Areas for Roaming” which belongs to either the selected
  SNPN or the registered SNPN of the UE.
```

In operation 14-55, the UE 14-01 may perform actions following cell selection while T311 is running. For example, the UE 14-01 may stop the running T311 timer and determine whether to perform a CHO recovery procedure. Specifically, the UE 14-01 may sequentially perform the actions disclosed in Table 14 below.

TABLE 14
Upon selecting a suitable NR cell, the UE shall:

| | |
|---|---|
| 1> | ensure having valid and up to date essential system |

information as specified in clause 5.2.2.2;

| | |
|---|---|
| 1> | stop timer T311; |
| 1> | if T390 is running: |
| 2> | stop timer T390 for all access categories; |
| 2> | perform the actions as specified in 5.3.14.4; |
| 1> | stop the relay (re)selection procedure, if ongoing; |
| 1> | if the cell selection is triggered by detecting radio link failure |

of the MCG or re-configuration with sync failure of the MCG or mobility from
NR failure, and

| | |
|---|---|
| 1> | if attemptCondReconfig is configured; and |
| 1> | if the selected cell is not configured with CondEventT1, or |

the selected cell is configured with CondEventT1 and leaving condition has
not been fulfilled; and

| | |
|---|---|
| 1> | if the selected cell is one of the candidate cells for which |

the reconfigurationWithSync is included in the masterCellGroup in the MCG
VarConditionalReconfig:

| | |
|---|---|
| 2> | if the UE supports RLF-Report for conditional handover, set |

```
  the choCellId in the VarRLF-Report to the global cell identity, if available,
  otherwise to the physical cell identity and carrier frequency of the selected
  cell;
```

| | |
|---|---|
| 2> | apply the stored condRRCReconfig associated to the |

selected cell and perform actions as specified in 5.3.5.3;

| | |
|---|---|
| NOTE 1: | It is left to network implementation to how to avoid |

```
    keystream reuse in case of CHO based recovery after a failed handover
    without key change.
```

| | |
|---|---|
| 1> | else: |
| 2> | if UE is configured with attemptCondReconfig: |
| 3> | reset MAC; |
| 3> | release spCellConfig, if configured; |
| 3> | release the MCG SCell(s), if configured; |
| 3> | release delayBudgetReportingConfig, if configured and stop |

timer T342, if running;

| | |
|---|---|
| 3> | release overheatingAssistanceConfig , if configured and stop |

timer T345, if running;

| | |
|---|---|
| 3> | if MR-DC is configured: |
| 4> | perform MR-DC release, as specified in clause |

5.3.5.10;

| | |
|---|---|
| 3> | release idc-AssistanceConfig, if configured; |
| 3> | release btNameList, if configured; |
| 3> | release wlanNameList, if configured; |
| 3> | release sensorNameList, if configured; |
| 3> | release drx-PreferenceConfig for the MCG, if configured and |

stop timer T346a associated with the MCG, if running;

| | |
|---|---|
| 3> | release maxBW-PreferenceConfig for the MCG, if configured |

and stop timer T346b associated with the MCG, if running;

| | |
|---|---|
| 3> | release maxCC-PreferenceConfig for the MCG, if configured |

and stop timer T346c associated with the MCG, if running;

| | |
|---|---|
| 3> | release maxMIMO-LayerPreferenceConfig for the MCG, if |

configured and stop timer T346d associated with the MCG, if running;

| | |
|---|---|
| 3> | release minSchedulingOffsetPreferenceConfig for the MCG, |

if configured and stop timer T346e associated with the MCG, if running;

| | |
|---|---|
| 3> | release rlm-RelaxationReportingConfig for the MCG, if |

configured and stop timer T346j associated with the MCG, if running;

| | |
|---|---|
| 3> | release bfd-RelaxationReportingConfig for the MCG, if |

configured and stop timer T346k associated with the MCG, if running;

| | |
|---|---|
| 3> | release releasePreferenceConfig, if configured and stop |

timer T346f, if running;

| | |
|---|---|
| 3> | release onDemandSIB-Request if configured, and stop timer |

T350, if running;

| | |
|---|---|
| 3> | release referenceTimePreferenceReporting, if configured; |
| 3> | release sl-AssistanceConfigNR, if configured; |
| 3> | release obtainCommonLocation, if configured; |
| 3> | release scg-DeactivationPreferenceConfig, if configured, and |

stop timer T346i, if running;

| | |
|---|---|
| 3> | release musim-GapAssistanceConfig, if configured and stop |

timer T346h, if running;

| | |
|---|---|
| 3> | release musim-LeaveAssistanceConfig, if configured; |
| 3> | release propDelayDiffReportConfig, if configured; |
| 3> | release ul-GapFR2-PreferenceConfig, if configured; |
| 3> | release rrm-MeasRelaxationReportingConfig, if configured; |
| 3> | release maxBW-PreferenceConfigFR2-2, if configured; |
| 3> | release maxMIMO-LayerPreferenceConfigFR2-2, if |

configured;

| | |
|---|---|
| 3> | release minSchedulingOffsetPreferenceConfigExt, if |

configured;

| | |
|---|---|
| 3> | suspend all RBs, and BH RLC channels for the IAB-MT, |

except SRB0 and broadcast MRBs;

| | |
|---|---|
| 2> | remove all the entries within the MCG |

VarConditionalReconfig, if any;

| | |
|---|---|
| 2> | for each measId, if the associated reportConfig has a |

reportType set to condTriggerConfig:

| | |
|---|---|
| 3> | for the associated reportConfigId: |
| 4> | remove the entry with the matching reportConfigId |

from the reportConfigList within the VarMeasConfig;

| | |
|---|---|
| 3> | if the associated measObjectId is only associated to a |

reportConfig with reportType set to condTriggerConfig:

| | |
|---|---|
| 4> | remove the entry with the matching measObjectId |

from the measObjectList within the VarMeasConfig;

| | |
|---|---|
| 3> | remove the entry with the matching measId from the |

measIdList within the VarMeasConfig;

| | |
|---|---|
| 2> | release the PC5 RLC entity for SL-RLC0, if any; |
| 2> | start timer T301; |
| 2> | apply the default L1 parameter values as specified in |

```
  corresponding physical layer specifications except for the parameters for
  which values are provided in SIB1;
```

| | |
|---|---|
| 2> | apply the default MAC Cell Group configuration as specified |

in 9.2.2;

| | |
|---|---|
| 2> | apply the CCCH configuration as specified in 9.1.1.2; |
| 2> | apply the timeAlignmentTimerCommon included in SIB1; |
| 2> | initiate transmission of the RRCReestablishmentRequest |

message in accordance with 5.3.7.4;

| | |
|---|---|
| NOTE 2: | This procedure applies also if the UE returns to the |

source PCell.

When the UE, according to an embodiment of the disclosure, performs the actions sequentially, it is assumed that the conditions are satisfied and the actions are performed as disclosed in Table 15 below, and this may be referred to as a CHO recovery procedure.

TABLE 15

```
  Condition:
    - if the cell selection is triggered by detecting radio link failure of the
MCG or re-configuration with sync failure of the MCG or mobility from NR
failure, and
    - if attemptCondReconfig is configured; and
    - if the selected cell is not configured with CondEventT1, or the
selected cell is configured with CondEventT1 and leaving condition has not
been fulfilled; and
    - if the selected cell is one of the candidate cells for which the
reconfiguration WithSync is included in the masterCellGroup in the MCG
VarConditionalReconfig:
  Action:
    - if the UE supports RLF-Report for conditional handover, set the
choCellId in the VarRLF-Report to the global cell identity, if available,
otherwise to the physical cell identity and carrier frequency of the selected
cell;
    - apply the stored condRRCReconfig associated to the selected cell
and perform actions as specified in 5.3.5.3 (For example, operation 12-40);
```

In operation 14-60, the UE 14-01 applies condRRCReconfig stored in association with the cell 14-03 selected in operation 14-55, and then transmits an RRC connection reconstitution complete message (RRCReconfigurationComplete) to the cell 14-03, so that the CHO recovery procedure may be successfully completed.

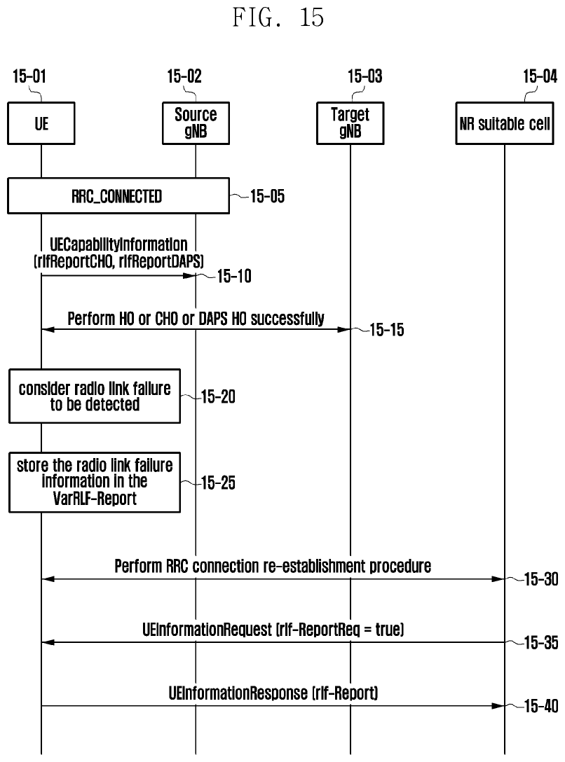

FIG. 15 illustrates a flowchart in which a UE stores RLF contents and reports the stored RLF contents upon request from a base station when a radio link failure is detected in a cell where the UE has successfully performed a handover (HO), conditional handover (CHO), or dual active protocol stack (DAPS) handover.

With reference to FIG. 15, a UE 15-01 may establish an RRC connection with an NR base station 15-02 and be in RRC connected mode (RRC_CONNECTED) (15-05).

In operation 15-10, the UE 15-01 may transmit a UE capability information message (UECapabilityInformation) to the NR base station 15-02. The UE capability information message may include at least one of the following indicators:
rlfReportCHO: Indicator indicating whether RLF-Report for conditional handover (CHO) is supported.
rlfReportDAPS: Indicator indicating whether RLF-Report for DAPS HO is supported.

In operation 15-15, the UE 15-01 may successfully perform handover (for example, FIG. 11) or conditional handover (for example, FIG. 12) or dual active protocol stack handover (for example, FIG. 13) with a target NR base station 15-03. For convenience of explanation, the process of the UE 15-01 successfully performing handover, conditional handover, or dual active protocol stack handover with the target NR base station 15-03 will be referred to the above-described embodiments. For reference, in an embodiment of the disclosure, a case where the UE successfully performs the CHO recovery procedure (for example, the embodiment disclosed in FIG. 14) may not refer to operation 15-15. For example, performing a CHO recovery procedure is not included in the actions disclosed in operation 15-15. Additionally, in an embodiment of the disclosure, operation 15-15 may also refer to a case where the UE successfully performs an RRC connection re-establishment procedure with the specific NR base station 15-03 after the UE fails the handover, conditional handover, or dual activation protocol stack handover (for example, the UE transmits RRCReestablishmentRequest to a specific base station, the specific base station transmits RRCSetup or RRCReestablishment in response thereto, and the UE transmits RRCSetupComplete or RRCReestablishmentComplete to the specific base station in final response).

In operation 15-20, radio link failure may be detected in the current PCell or current master cell group (MCG) 15-03 of the UE 15-01. For example, the UE 15-01 may determine or consider that a radio link failure has been detected in the PCell where the above-described handover has been successfully performed.

In operation 15-25, the UE 15-01 may store radio link failure information in a VarRLF-Report variable. For example, the UE 15-01 may store the radio link failure information in the VarRLF-Report variable based on the detection of the radio link failure. The UE, according to an embodiment of the disclosure, proposes to store the following information in the VarRLF-Report variable:
Include nrPreviousCell in a previousPCellId field and set the nrPreviousCell to the global cell identity and tracking area code of the PCell that has performed the most recent RRC connection reconfiguration message including reconfiguration WithSync (include the nrPreviousCell in previousPCellId and set it to the global cell identity and the tracking area code of the PCell where the last executed RRCReconfiguration message including reconfigurationWithSync was received). In other words, it may mean the global cell identity and tracking area code for the PCell of the NR base station 15-02.
In a case where DAPS HO has been performed in operation 15-15, lastHO-Type may be set to daps (if the last executed RRCReconfiguration message including reconfigurationWithSync was concerning a DAPS handover, set lastHO-Type to daps).
In a case where CHO has been performed in operation 15-15, lastHO-Type may be set to cho (else if the last executed RRCReconfiguration message including reconfiguration WithSync was concerning a conditional handover, set lastHO-Type to cho).
In operation 15-15, the elapsed time from the time when the most recent RRC connection reconfiguration message including reconfigurationWithySync has been performed to the time when radio link failure has been detected may be set to timeConnFailure (set the timeConnFailure to the elapsed time since the execution of the last RRCReconfiguration message including the reconfiguration WithSync)

The UE 15-01 according to an embodiment of the disclosure may store the information in the VarRLF-Report variable and report the information at a later request of the base station 15-04. Based on the above information, the base station 15-04 may determine how the handover, conditional handover, or DAPS handover has been performed before the radio link failure is occurred. Alternatively, there is an advantage that based on the information, the base station 15-04 can tune parameters necessary for each handover in the future. For example, in a case where the elapsed time for timeConnFailure is too short, the base station 15-04 may determine that the UE 15-01 hastily performed a quick handover (too early HO, too early CHO, too early DAPS), and accordingly, may instruct the UE 15-01 to perform a handover to a more suitable target cell later. For reference, additionally, the UE 15-01, according to an embodiment of the disclosure, may apply information indicating that RLF is detected in the source PCell in a case where DAPS handover is successful, but RLF is detected in the source PCell, or the above-described contents (the above information stored in the VarRLF-Report variable) even in a case where the DAPS handover to the target PCell fails but the connection to the source PCell continues. Additionally, in a case where the DAPS handover to the target PCell fails but the connection to the source PCell continues, the UE may not include the above-described contents or may not include only the nrPreviousPCellId.

The UE 15-01, according to an embodiment of the disclosure, may not store previousPCellId, lastTypeHO, and timeConnFailure in the VarRLF-Report variable in a case where the oldest PCell 15-03 is a PCell through the CHO recovery procedure.

Specifically, the UE 15-01 may store radio link failure information in the VarRLF-Report variable through the procedure disclosed in Table 16 below.

TABLE 16
5.3.10.5 RLF report content determination

The UE shall determine the content in the VarRLF-Report as follows:

| | |
|---|---|
| 1> | clear the information included in VarRLF-Report, if any; |
| 1> | set the plmn-IdentityList to include the list of EPLMNs stored |

by the UE (i.e. includes the RPLMN);

| | |
|---|---|
| 1> | set the measResultLastServCell to include the cell level |

RSRP, RSRQ and the available SINR, of the source PCell (in case HO failure)
or PCell (in case RLF) based on the available SSB and CSI-RS measurements
collected up to the moment the UE detected failure;

| | |
|---|---|
| 1> | if the SS/PBCH block-based measurement quantities are |

available:

| | |
|---|---|
| 2> | set the rsIndexResults in measResultLastServCell to include |

```
  all the available measurement quantities of the source PCell (in case HO
  failure) or PCell (in case RLF), ordered such that the highest SS/PBCH
  block RSRP is listed first if SS/PBCH block RSRP measurement results are
  available, otherwise the highest SS/PBCH block RSRQ is listed first if
  SS/PBCH block RSRQ measurement results are available, otherwise the
  highest SS/PBCH block SINR is listed first, based on the available
  SS/PBCH block based measurements collected up to the moment the UE
  detected failure;
```

| | |
|---|---|
| 1> | if the CSI-RS based measurement quantities are available: |
| 2> | set the rsIndexResults in measResultLastServCell to include |

```
  all the available measurement quantities of the source PCell (in case HO
  failure) or PCell (in case RLF), ordered such that the highest CSI-RS RSRP
  is listed first if CSI-RS RSRP measurement results are available, otherwise
  the highest CSI-RS RSRQ is listed first if CSI-RS RSRQ measurement
  results are available, otherwise the highest CSI-RS SINR is listed first,
  based on the available CSI-RS based measurements collected up to the
  moment the UE detected failure;
```

| | |
|---|---|
| 1> | set the ssbRLMConfigBitmap and/or csi-rsRLMConfigBitmap |

in measResultLastServCell to include the radio link monitoring configuration
of the source PCell (in case HO failure) or PCell (in case RLF), if available;

| | |
|---|---|
| 1> | for each of the configured measObjectNR in which |

measurements are available:

| | |
|---|---|
| 2> | if the SS/PBCH block-based measurement quantities are |

available:

| | |
|---|---|
| 3> | set the measResultListNR in measResultNeighCells to |

```
    include all the available measurement quantities of the best measured
    cells, other than the source PCell (in case HO failure) or PCell (in case
    RLF), ordered such that the cell with highest SS/PBCH block RSRP is
    listed first if SS/PBCH block RSRP measurement results are available,
    otherwise the cell with highest SS/PBCH block RSRQ is listed first if
    SS/PBCH block RSRQ measurement results are available, otherwise the
    cell with highest SS/PBCH block SINR is listed first, based on the
    available SS/PBCH block based measurements collected up to the
    moment the UE detected failure;
```

| | |
|---|---|
| 4> | for each neighbour cell included, include the |

optional fields that are available;

| | |
|---|---|
| 2> | if the CSI-RS based measurement quantities are available: |
| 3> | set the measResultListNR in measResultNeighCells to |

```
    include all the available measurement quantities of the best measured
    cells, other than the source PCell (in case HO failure) or PCell (in case
    RLF), ordered such that the cell with highest CSI-RS RSRP is listed first if
    CSI-RS RSRP measurement results are available, otherwise the cell with
    highest CSI-RS RSRQ is listed first if CSI-RS RSRQ measurement results
    are available, otherwise the cell with highest CSI-RS SINR is listed first,
    based on the available CSI-RS based measurements collected up to the
    moment the UE detected radio link failure;
```

| | |
|---|---|
| 4> | for each neighbour cell included, include the |

optional fields that are available;

| | |
|---|---|
| 2> | for each neighbour cell, if any, included in measResultListNR |

in measResultNeighCells:

| | |
|---|---|
| 3> | if the UE supports RLF-Report for conditional handover and |

```
    if the neighbour cell is one of the candidate cells for which the
    reconfigurationWithSync is included in the masterCellGroup in the MCG
    VarConditionalReconfig at the moment of the detected failure:
```

| | |
|---|---|
| 4> | set choConfig in MeasResult2NR to the execution |

```
      condition for each measId within condTriggerConfig associated to the
      neighbour cell within the MCG VarConditionalReconfig;
```

| | |
|---|---|
| 4> | if the first entry of choConfig corresponds to a |

```
      fulfilled execution condition at the moment of handover failure, or
      radio link failure; or
```

| | |
|---|---|
| 4> | if the second entry of choConfig, if available, |

```
      corresponds to a fulfilled execution condition at the moment of
      handover failure, or radio link failure:
```

| | |
|---|---|
| 5> | set firstTriggeredEvent to the execution condition |

```
        condFirstEvent corresponding to the first entry of choConfig or to
        the execution condition condSecondEvent corresponding to the
        second entry of choConfig, whichever execution condition was
        fulfilled first in time;
```

| | |
|---|---|
| 5> | set timeBetweenEvents to the elapsed time between |

```
        the point in time of fullfilling the condition in choConfig that was
        fulfilled first in time, and the point in time of fullfilling the condition
        in choConfig that was fulfilled second in time, if both the first
        execution condition corresponding to the first entry and the
        second execution condition corresponding to the second entry in
        the choConfig were fullfilled;
```

| | |
|---|---|
| 1> | for each of the configured EUTRA frequencies in which |

measurements are available;

| | |
|---|---|
| 2> | set the measResultListEUTRA in measResultNeighCells to |

```
  include the best measured cells ordered such that the cell with highest
  RSRP is listed first if RSRP measurement results are available, otherwise
  the cell with highest RSRQ is listed first, and based on measurements
  collected up to the moment the UE detected failure;
```

| | |
|---|---|
| 3> | for each neighbour cell included, include the optional fields |

that are available;

| | |
|---|---|
| NOTE 1: | The measured quantities are filtered by the L3 filter |

```
    as configured in the mobility measurement configuration. The
    measurements are based on the time domain measurement resource
    restriction, if configured. Exclude-listed cells are not required to be
    reported.
```

| | |
|---|---|
| 1> | set the c-RNTI to the C-RNTI used in the source PCell (in |

case HO failure) or PCell (in case RLF);

| | |
|---|---|
| 1> | else if the failure is detected due to radio link failure as |

described in 5.3.10.3, set the fields in VarRLF-report as follows:

| | |
|---|---|
| 2> | set the connectionFailure Type to rlf; |
| 2> | set the rlf-Cause to the trigger for detecting radio link failure |

in accordance with clause 5.3.10.4;

| | |
|---|---|
| 2> | set the nrFailedPCellId in failedPCellId to the global cell |

```
  identity and the tracking area code, if available, and otherwise to the
  physical cell identity and carrier frequency of the PCell where radio link
  failure is detected;
```

| | |
|---|---|
| 2> | if an RRCReconfiguration message including the |

reconfigurationWithSync was received before the connection failure:

| | |
|---|---|
| 3> | if the last executed RRCReconfiguration message including |

```
    the reconfigurationWithSync concerned an intra NR handover and it was
    received while connected to the previous PCell to which the UE was
    connected before connecting to the PCell where radio link failure is
    detected; and
```

| | |
|---|---|
| 3> | if the PCell in which the radio link failure was detected was |

```
    not a result of a conditional reconfiguration execution upon cell
    selection performed while timer T311 was running as defined in 5.3.7.3:
```

| | |
|---|---|
| 4> | include the nrPreviousCell in previousPCellId and set |

```
      it to the global cell identity and the tracking area code of the PCell
      where the last executed RRCReconfiguration message including
      reconfigurationWithSync was received;
```

| | |
|---|---|
| 4> | if the last executed RRCReconfiguration message |

including reconfigurationWithSync was concerning a DAPS handover:

| | |
|---|---|
| 5> | set lastHO-Type to daps; |

| | |
|---|---|
| 4> | else if the last executed RRCReconfiguration |

```
      message including reconfigurationWithSync was concerning a
      conditional handover:
```

| | |
|---|---|
| 5> | set lastHO-Type to cho; |

| | |
|---|---|
| 4> | set the timeConnFailure to the elapsed time since |

```
      the execution of the last RRCReconfiguration message including the
      reconfigurationWithSync;
```

| | |
|---|---|
| 3> | else if the last RRCReconfiguration message including the |

```
    reconfigurationWithSync concerned a handover to NR from E-UTRA and
    if the UE supports Radio Link Failure Report for Inter-RAT MRO EUTRA:
```

| | |
|---|---|
| 4> | include the eutraPreviousCell in previousPCellId and |

```
      set it to the global cell identity and the tracking area code of the E-
      UTRA PCell where the last RRCReconfiguration message including
      reconfigurationWithSync was received embedded in E-UTRA RRC
      message MobilityFromEUTRACommand message as specified in TS
      36.331 [10] clause 5.4.3.3;
```

| | |
|---|---|
| 4> | set the timeConnFailure to the elapsed time since |

```
      reception of the last RRCReconfiguration message including the
      reconfigurationWithSync embedded in E-UTRA RRC message
      MobilityFromEUTRACommand message as specified in TS 36.331
      [10] clause 5.4.3.3;
```

| | |
|---|---|
| 2> | if configuration of the conditional handover is available in |

```
  the MCG VarConditionalReconfig at the moment of declaring the radio link
  failure:
```

| | |
|---|---|
| 3> | set timeSinceCHO-Reconfig to the time elapsed between the |

```
    detection of the radio link failure, and the reception, in the source PCell,
    of the last conditionalReconfiguration including the condRRCReconfig
    message;
```

| | |
|---|---|
| 3> | set choCandidateCellList to include the global cell identity if |

```
    available, and otherwise to the physical cell identity and carrier
    frequency of each of all the candidate target cells for conditional
    handover included in condRRCReconfig within the MCG
    VarConditionalReconfig at the time of radio link failure, excluding the
    candidate target cells included in measResulNeighCells;
```

| | |
|---|---|
| 1> | if connectionFailureType is rlf and the rlf-Cause is set to |

randomAccessProblem or beamFailureRecoveryFailure; or

| | |
|---|---|
| 1> | if connectionFailureType is hof and if the failed handover is |

an intra-RAT handover:

| | |
|---|---|
| 2> | set the ra-InformationCommon to include the random- |

access related information as described in clause 5.7.10.5;

| | |
|---|---|
| 1> | if available, set the locationInfo as in 5.3.3.7. |

In operation 15-30, the UE 15-01 may perform an RRC connection re-establishment procedure. As an example, the UE 15-01 may run a T311 timer and select an NR suitable cell 15-04 through a cell selection procedure. Further, the UE 15-01 may perform the CHO recovery procedure of the above-described embodiment or transmit an RRC connection re-establishment request message (RRCReestablishmentRequest) to the NR suitable cell 15-04. The NR suitable cell 15-04 transmits an RRC connection re-establishment message (RRCRestablishment) to the UE 15-01, and the UE 15-01 considers the NR suitable cell 15-04 to be a PCell, and transmit the RRC connection re-establishment complete message to the current PCell 15-04, thereby completing the RRC connection re-establishment procedure. For reference, when transmitting the RRC connection reconstitution complete message (RRCReconfigurationComplete) through the CHO recovery procedure or an RRC connection re-establishment complete message (RRCReestablishmentComplete) through the RRC connection re-establishment procedure to the current PCell 15-04, the UE 15-01 may include rlf-InfoAvailable in the RRC connection reconstitution complete message or RRC connection re-establishment complete message in a case where the conditions disclosed in Table 17 below are satisfied.

```
TABLE 17
  - if the UE has radio link failure or handover failure information
available in VarRLF-Report and if the RPLMN is included in plmn-IdentityList
stored in VarRLF-Report; or
  - if the UE has radio link failure or handover failure information
available in VarRLF-Report of TS 36.331 [10] and if the UE is capable of
cross-RAT RLF reporting and if the RPLMN is included in plmn-IdentityList
stored in VarRLF-Report of TS 36.331 [10]:
```

In operation 15-35, the NR base station 15-04 may transmit a UE information request message (UEInformationRequest) to the UE 15-01 in order to retrieve the RLF-Report from the UE 15-01. Further, rlf-ReportReq in the above message may be set to true.

In operation 15-40, the UE 15-01 may transmit a UE information response message (UEInformationResponse) to the NR base station 15-04 to report the RLF-Report. Specifically, the UE 15-01 may transmit the UE information response message to the NR base station 15-04 by including the RLF-Report in the UE information response message through the procedure disclosed in Table 18 below.

TABLE 18

| | |
|---|---|
| 2> | if the UE has radio link failure information or handover |

failure information available in VarRLF-Report and if the RPLMN is included
in plmn-IdentityList stored in VarRLF-Report:

| | |
|---|---|
| 3> | set timeSinceFailure in VarRLF-Report to the time that |

elapsed since the last radio link failure or handover failure in NR;

| | |
|---|---|
| 3> | set the rlf-Report in the UEInformationResponse message to |

the value of rlf-Report in VarRLF-Report;

| | |
|---|---|
| 3> | discard the rlf-Report from VarRLF-Report upon successful |

```
  delivery of the UEInformationResponse message confirmed by lower
  layers;
```

| | |
|---|---|
| 2> | else if the UE is capable of cross-RAT RLF reporting as |

defined in TS 38.306 [26] and has radio link failure information or handover
failure information available in VarRLF-Report of TS 36.331 [10] and if the
RPLMN is included in plmn-IdentityList stored in VarRLF-Report of TS
36.331 [10]:

| | |
|---|---|
| 3> | set timeSinceFailure in VarRLF-Report of TS 36.331 [10] to |

```
  the time that elapsed since the last radio link failure or handover failure
  in EUTRA;
```

| | |
|---|---|
| 3> | set failedPCellId-EUTRA in the rlf-Report in the |

```
  UEInformationResponse message to indicate the PCell in which RLF was
  detected or the source PCell of the failed handover in the VarRLF-Report
  of TS 36.331 [10];
```

| | |
|---|---|
| 3> | set the measResult-RLF-Report-EUTRA in the rlf-Report in the |

```
  UEInformationResponse message to the value of rlf-Report in VarRLF-
  Report of TS 36.331 [10];
```

| | |
|---|---|
| 3> | discard the rlf-Report from VarRLF-Report of TS 36.331 [10] |

```
  upon successful delivery of the UEInformationResponse message
  confirmed by lower layers;
```

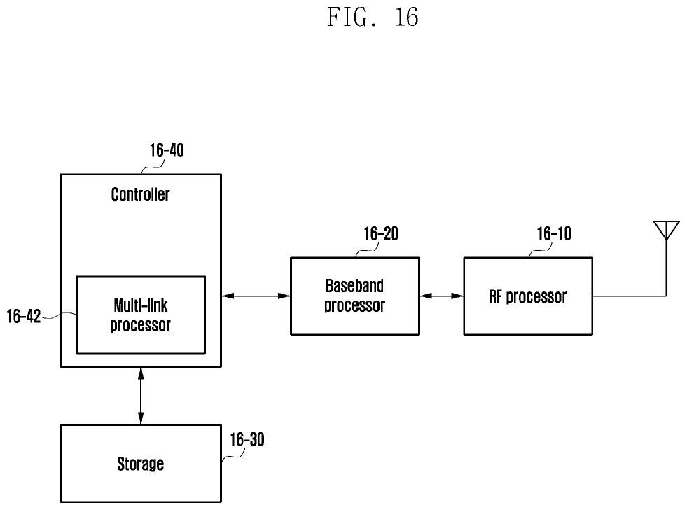

Meanwhile, FIG. 16 illustrates a block diagram for an internal architecture of a UE according to an embodiment of the disclosure.

With reference to FIG. 16, the UE may include a radio frequency (RF) processor 16-10, a baseband processor 16-20, a storage 16-30, and a controller 16-40.

The RF processor 16-10 performs functions for transmitting and receiving signals through wireless channels, e.g., band conversion and amplification of the signals. For example, the RF processor 16-10 up-converts a baseband signal provided from the baseband processor 16-20, into an RF band signal and then transmits the RF band signal through an antenna, and down-converts an RF band signal received through the antenna, into a baseband signal. For example, the RF processor 16-10 may include a transmit filter, a receive filter, an amplifier, a mixer, an oscillator, a digital to analog convertor (DAC), an analog to digital convertor (ADC), and the like. Although only one antenna is illustrated in the drawing, the UE may include a plurality of antennas. Also, the RF processor 16-10 may include a plurality of RF chains. Furthermore, the RF processor 16-10 may perform beamforming. For beamforming, the RF processor 16-10 may adjust phases and intensities of signals to be transmitted or received through a plurality of antennas or antenna elements. The RF processor may perform MIMO and receive data of a plurality of layers in the MIMO operation.

The baseband processor 16-20 performs a convert function between a baseband signal and a bitstream based on physical layer specifications of a system. For example, for data transmission, the baseband processor 16-20 may generate complex symbols by encoding and modulating a transmit bitstream. Also, for data reception, the baseband processor 16-20 may reconstruct a received bitstream by demodulating and decoding a baseband signal provided from the RF processor 16-10. For example, according to an orthogonal frequency division multiplexing (OFDM) scheme, for data transmission, the baseband processor 16-20 may generate complex symbols by encoding and modulating a transmit bitstream, map the complex symbols to subcarriers, and then constitute OFDM symbols by performing inverse fast Fourier transformation (IFFT) operation and cyclic prefix (CP) insertion. Also, for data reception, the baseband processor 16-20 segments a baseband signal provided from the RF processor 16-10, into OFDM symbol units, reconstruct signals mapped to subcarriers by performing fast Fourier transformation (FFT), and then reconstruct a received bitstream by demodulating and decoding the signals.

The baseband processor 16-20 and RF processor 16-10 may transmit and receive signals as described above. As such, the baseband processor 16-20 and RF processor 16-10 may also be called a transmitter, a receiver, a transceiver, or a communicator. Furthermore, at least one of the baseband processor 16-20 or the RF processor 16-10 may include a plurality of communication modules to support a plurality of different radio access technologies. In addition, at least one of the baseband processor 16-20 or the RF processor 16-10 may include different communication modules to process signals of different frequency bands. For example, the different radio access technologies may include a wireless LAN (e.g., IEEE 802.11), a cellular network (e.g., an LTE), and the like. In addition, the different frequency bands may include a super-high frequency (SHF) (for example, 2.NRHz, NRhz) band and a millimeter wave (mmWave) (for example, 60 GHz) band.

The storage 16-30 may store data such as basic programs, application programs, and configuration information for operations of the UE. In particular, the storage 16-30 may store information related to a second access node that performs wireless communication using a second wireless access technology. Also, the storage 16-30 provides the stored data upon request by the controller 16-40.

The controller 16-40 may control overall operations of the UE. For example, the controller 16-40 transmits and receives signals through the baseband processor 16-20 and RF processor 16-10. In addition, the controller 16-40 records and reads data on or from the storage 16-30. In this regard, the controller 16-40 may include at least one processor. For example, the controller 16-40 may include a communication processor (CP) for controlling communications and an application processor (AP) for controlling an upper layer such as an application program.

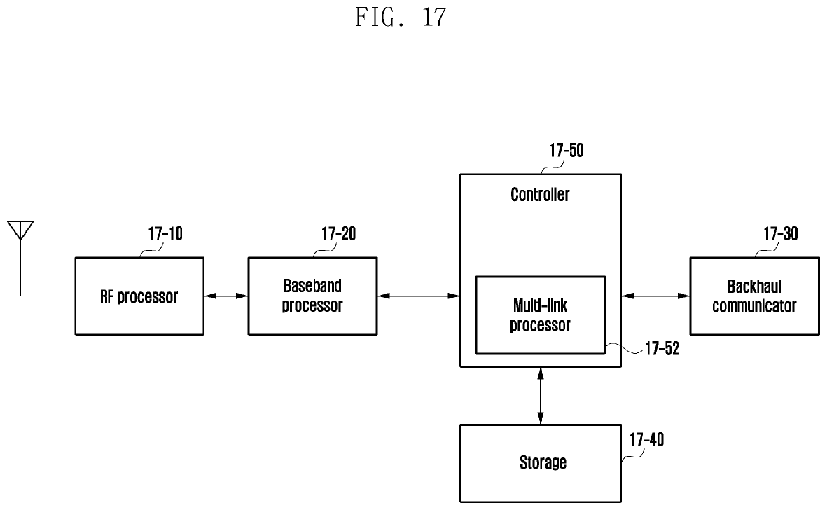

Meanwhile, FIG. 17 illustrates a block diagram for an architecture of a base station according to an embodiment of the disclosure. According to an embodiment, the base station may be an NR base station.

As illustrated in FIG. 17, the base station may include an RF processor 17-10, a baseband processor 17-20, a backhaul communicator 17-30, a storage 17-40, and a controller 17-50.

The RF processor 17-10 may perform functions for transmitting and receiving signals through wireless channels, e.g., band conversion and amplification of the signals. That is, the RF processor 17-10 up-converts a baseband signal provided from the baseband processor 17-20, into an RF band signal and then transmits the RF band signal through an antenna, and down-converts an RF band signal received through an antenna, into a baseband signal. For example, the RF processor 17-10 may include a transmit filter, a receive filter, an amplifier, a mixer, an oscillator, a DAC, an ADC, and the like. Although only one antenna is illustrated in the drawing, the first access node may include a plurality of antennas. In addition, the RF processor 17-10 may include a plurality of RF chains. Furthermore, the RF processor 17-10 may perform beamforming. For beamforming, the RF processor 17-10 may adjust phases and intensities of signals to be transmitted or received through a plurality of antennas or antenna elements. The RF processor may perform downlink MIMO operation by transmitting data of one or more layers.

The baseband processor 17-20 performs a convert function between a baseband signal and a bitstream based on physical layer specifications of a first radio access technology. For example, for data transmission, the baseband processor 17-20 may generate complex symbols by encoding and modulating a transmit bitstream. Also, for data reception, the baseband processor 17-20 reconstructs a received bitstream by demodulating and decoding a baseband signal provided from the RF processor 17-10. For example, according to an OFDM scheme, for data transmission, the baseband processor 17-20 generates complex symbols by encoding and modulating a transmit bitstream, maps the complex symbols to subcarriers, and then constitutes OFDM symbols by performing IFFT operation and CP insertion. Also, for data reception, the baseband processor 17-20 segments a baseband signal provided from the RF processor 17-10, into OFDM symbol units, reconstructs signals mapped to subcarriers by performing FFT operation, and then reconstructs a received bitstream by demodulating and decoding the signals. The baseband processor 17-20 and RF processor 17-10 transmits and receives signals as described above. As such, the baseband processor 17-20 and RF processor 17-10 may be called a transmitter, a receiver, a transceiver, a communicator, or a wireless communicator.

The backhaul communicator 17-30 provides an interface for communicating with other nodes in a network. That is, the backhaul communicator 17-30 converts a bitstream to be transmitted from a primary base station to another node, e.g., a secondary base station or a core network, into a physical signal, and converts a physical signal received from the other node, into a bitstream.

The storage 17-40 stores data such as basic programs, application programs, and configuration information for operations of the primary base station. Specifically, the storage 17-40 may store information about bearers assigned for a connected UE and measurement results reported from the connected UE. Also, the storage 17-40 may store criteria information used to determine whether to provide or release multiple connections to or from the UE. Also, the storage 17-40 provides the stored data upon request by the controller 17-50.

The controller 17-50 controls overall operations of the primary base station. For example, the controller 17-50 transmits and receives signals through the baseband processor 17-20 and RF processor 17-10, or through the backhaul communicator 17-30. Also, the controller 17-50 records and reads data on or from the storage 17-40. In this regard, the controller 17-50 may include at least one processor.

The methods according to the embodiments of the disclosure as described herein or in the claims may be implemented as hardware, software, or a combination of hardware and software.

When implemented as software, a computer-readable storage medium storing one or more programs (e.g., software modules) may be provided. The one or more programs stored in the computer-readable storage medium are configured for execution by one or more processors in an electronic device. The one or more programs include instructions directing the electronic device to execute the methods according to the embodiments of the disclosure as described herein or in the claims.

The programs (e.g., software modules or software) may be stored in non-volatile memory including random access memory or flash memory, read only memory (ROM), electrically erasable programmable read only memory (EEPROM), a magnetic disc storage device, a compact disc (CD)-ROM, a digital versatile disc (DVD), another optical storage device, or a magnetic cassette. Alternatively, the programs may be stored in memory including a combination of some or all of the above-mentioned storage media. Also, a plurality of such memories may be included.

In addition, the programs may be stored in an attachable storage device accessible through any or a combination of communication networks such as the Internet, an intranet, a local area network (LAN), a wide LAN (WLAN), and a storage area network (SAN). Such a storage device may access an apparatus performing the embodiments of the disclosure via an external port. Furthermore, an additional storage device on the communication network may access the apparatus performing the embodiments of the disclosure.

In the afore-described embodiments of the disclosure, an element or elements included in the disclosure are expressed in a singular or plural form depending on the described embodiments of the disclosure. However, the singular or plural form is selected appropriately for a situation assumed for convenience of description, the disclosure is not limited to the singular or plural form, and an element expressed in a singular form may include a plurality of elements and elements expressed in a plural form may include a single element.

While the disclosure has been shown and described with reference to certain embodiments thereof, it is apparent that various changes may be made therein without departing from the scope of the disclosure. Thus, the scope of the disclosure should not be limited to the described embodiments, but should be defined by the following claims and their equivalents.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
in case that a radio link failure (RLF) for a cell is detected, identifying whether a handover from a previous cell to the cell is successfully performed, and identifying whether the handover is associated with a conditional handover (CHO) recovery; and
in case that the handover is successfully performed and the handover is not associated with the CHO recovery, storing link failure information to a variable of a RLF report.

2. The method of claim 1, wherein the identifying whether the handover is associated with the CHO recovery comprises:
identifying whether a timer is running before entering the cell; and
in case that the time is not running before entering the cell, determining that the handover is not associated with the CHO recovery.

3. The method of claim 1, wherein the storing the link failure information comprises:
including information on the previous cell in a field for the previous cell; and
setting the information on the previous cell to a global cell identity and a tracking area code of the previous cell.

4. The method of claim 1, wherein the storing the link failure information comprises:
identifying whether handover is a dual active protocol stack (DAPS) handover; and
in case that the handover is the DAPS handover, setting a field for a last handover type to DAPS;
identifying whether handover is a CHO handover,
in case that the handover is the CHO handover, setting the field for the last handover type to CHO; and
setting a field for a time to an elapsed time since the handover is successfully performed until the RLF for the cell is detected.

5. The method of claim 1, further comprising performing a radio resource control (RRC) connection re-establishment procedure.

6. A method performed by a terminal in a wireless communication system, the method comprising:
identifying whether information on a measurement logging is configured;
in case that the information on the measurement logging is configured, identifying whether an in-device coexistence (IDC) problem is detected on at least one inter-radio access technology (RAT) frequency during a last logging interval; and
in case that the IDC problem is detected on the at least one RAT frequency during the last logging interval, suspending the measurement logging.

7. The method of claim 6, wherein the at least one RAT frequency includes a frequency associated with a long term evolution (LTE).

8. The method of claim 6, wherein the suspending the measurement logging comprises:
identifying whether a field for a measurement result in a serving cell in a variable value of a logging measurement report is empty; and
in case that the field for the measurement result in the serving cell in the variable value of the logging measurement report is empty, suspending the measurement logging.

9. The method of claim 6, further comprising:
identifying whether a field for a measurement result in a serving cell in a variable value of a logging measurement report is empty;
in case that the field for the measurement result in the serving cell in the variable value of the logging measurement report is not empty, including information indicating that the measurement logging is suspended due to the IDC problem detection to the variable value of the logging measurement report; and
suspending the measurement logging from a next logging interval.

10. The method of claim 6, further comprising:
identifying whether the measurement logging is suspended, while a timer is running and a small data transmission (SDT) procedure is not going;
in case that the measurement logging is suspended, identifying whether during the last logging interval the IDC problem detected by the terminal is resolved; and
in case that during the last logging interval the IDC problem detected by the terminal is resolved, resuming the measurement logging.

11. A terminal in a wireless communication system, the terminal comprising:
a transceiver; and
at least one processor configured to:
in case that a radio link failure (RLF) for a cell is detected, identify whether a handover from a previous cell to the cell is successfully performed, and identify whether the handover is associated with a conditional handover (CHO) recovery, and,
in case that the handover is successfully performed and the handover is not associated with the CHO recovery, store link failure information to a variable of a RLF report.

12. The terminal of claim 11, wherein the at least one processor is further configured to:
identify whether a timer is running before entering the cell, and
in case that the timer is not running before entering the cell, determine that the handover is not associated with the CHO recovery.

13. The terminal of claim 11, wherein the at least one processor is further configured to:
include information on the previous cell in a field for the previous cell, and
set the information on the previous cell to a global cell identity and a tracking area code of the previous cell.

14. The terminal of claim 11, wherein the at least one processor is further configured to:
identify whether handover is a dual active protocol stack (DAPS) handover,
in case that the handover is the DAPS handover, set a field for a last handover type to DAPS,
identify whether handover is a CHO handover,
in case that the handover is the DAPS handover, set the field for the last handover type to CHO, and
set a field for a time to an elapsed time since the handover is successfully performed until the RLF for the cell is detected.

15. The terminal of claim 11, wherein the at least one processor is further configured to perform a radio resource control (RRC) connection re-establishment procedure.

16. A terminal in a wireless communication system, the terminal comprising:
a transceiver; and
at least one processor configured to:
identify whether information on a measurement logging is configured,
in case that the information on the measurement logging is configured, identify whether an in-device coexistence (IDC) problem is detected on at least one inter-radio access technology (RAT) frequency during a last logging interval,
in case that the IDC problem is detected on the at least one RAT frequency during the last logging interval, suspend the measurement logging.

17. The terminal of claim 16, wherein the at least one RAT frequency includes a frequency associated with a long term evolution (LTE).

18. The terminal of claim 16, wherein the at least one processor is further configured to:
identify whether a field for a measurement result in a serving cell in a variable value of a logging measurement report is empty, and
in case that the field for the measurement result in the serving cell in the variable value of the logging measurement report is empty, suspend the measurement logging.

19. The terminal of claim 16, wherein the at least one processor is further configured to:
identify whether a field for a measurement result in a serving cell in a variable value of a logging measurement report is empty; and
in case that the field for the measurement result in the serving cell in the variable value of the logging measurement report is not empty, include information indicating that the measurement logging is suspended due to the IDC problem detection to the the variable value of the logging measurement report and suspend the measurement logging from a next logging interval.

20. The terminal of claim 16, wherein the at least one processor is further configured to:
identify whether the measurement logging is suspended, while a timer is running and a small data transmission (SDT) procedure is not going,
in case that the measurement logging is suspended, identify whether during the last logging interval the IDC problem detected by the terminal is resolved, and
in case that during the last logging interval the IDC problem detected by the terminal is resolved, resume the measurement logging.
